(19) United States
(12) Patent Application Publication
(10) Pub. No.: US 2025/0048238 A1
(43) Pub. Date: Feb. 6, 2025

(54) WIRELESS COMMUNICATION METHOD AND NETWORK DEVICE

(71) Applicant: GUANGDONG OPPO MOBILE TELECOMMUNICATIONS CORP., LTD., Dongguan (CN)

(72) Inventor: Jingran CHEN, Dongguan (CN)

(21) Appl. No.: 18/917,996

(22) Filed: Oct. 16, 2024

Related U.S. Application Data
(63) Continuation of application No. PCT/CN2022/088600, filed on Apr. 22, 2022.

(51) Int. Cl. H04W 48/16; H04L 5/00

(52) U.S. Cl. CPC H04W 48/16; H04L 5/0048

(57) ABSTRACT

Provided is a wireless communication method, which is applicable to a network device. The method includes: acquiring first information, wherein the first information is used for requesting target information by a terminal device; acquiring network consent information of the terminal device based on the first information; and determining, based on the network consent information

### CROSS-REFERENCE TO RELATED APPLICATION

This application is a continuation of International Application No. PCT/CN2022/088600, filed Apr. 22, 2022, the entire disclosure of which is incorporated herein by reference.

### TECHNICAL FIELD

Embodiments of the present disclosure relate to the communication field, and in particular, to a wireless communication method and a device.

### BACKGROUND

In a 5th-generation (5G) communication system, a network data analytics function (NWDAF) network element is added to a core network. The NWDAF network element is configured to collect data from other core network elements, a network management system, or the like to perform big data statistics collection or analysis, or intelligent data analysis and acquire analytics or prediction data on a network side, to assist each core network element in more effectively controlling the access of a terminal device based on a data analytics result. The NWDAF network element provides various analytics results, which have great significance for the terminal device. For example, the analytics results assist the terminal device in deciding on an artificial intelligence (AI) operation. Therefore, how to expose information to the terminal device is an urgent problem to be resolved.

### SUMMARY

The present disclosure provides a wireless communication method and a network device.

According to some embodiments of the present application, a wireless communication method is provided. The method includes:
acquiring, by a network device, first information, wherein the first information is used for requesting target information by a terminal device;
acquiring network consent information of the terminal device based on the first information; and
determining, based on the network consent information of the terminal device, whether the terminal device is allowed to request the target information.

According to some embodiments of the present application, a network device is provided. The network device includes a processor and a memory. The memory is configured to store one or more computer programs. The processor, when calling and running the one or more computer programs stored in the memory, is caused to perform:
acquiring first information, wherein the first information is used for requesting target information by a terminal device;
acquiring network consent information of the terminal device based on the first information; and
determining, based on the network consent information of the terminal device, whether the terminal device is allowed to request the target information.

### BRIEF DESCRIPTION OF DRAWINGS

FIG. 1 is a schematic diagram of an architecture of a communication system according to some embodiments of the present disclosure;

FIG. 2 is a schematic connection diagram of a data collection application function (DCAF) architecture;

FIG. 3 is a schematic diagram of a federated learning (FL) architecture;

FIG. 4 is a schematic diagram of splitting an AI/machine learning (ML) operation structure;

FIG. 5 is a schematic diagram of an interface between an NWDAF network element and another network element;

FIG. 6 is a schematic diagram of an interface between an NWDAF network element and another network element;

FIG. 7 is a schematic diagram of a wireless communication method according to some embodiments of the present disclosure;

FIG. 8 is a schematic interaction diagram of a wireless communication method according to some embodiments of the present disclosure;

FIG. 9 is a schematic interaction diagram of another wireless communication method according to some embodiments of the present disclosure;

FIG. 10 is a schematic diagram of another wireless communication method according to some embodiments of the present disclosure;

FIG. 11 is a schematic diagram of another wireless communication method according to some embodiments of the present disclosure;

FIG. 12 is a schematic diagram of another wireless communication method according to some embodiments of the present disclosure;

FIG. 13 is a schematic diagram of another wireless communication method according to some embodiments of the present disclosure;

FIG. 14 is a schematic interaction diagram of a wireless communication method according to some embodiments of the present disclosure;

FIG. 15 is a schematic interaction diagram of a wireless communication method according to some embodiments of the present disclosure;

FIG. 16 is a schematic interaction diagram of a wireless communication method according to some embodiments of the present disclosure;

FIG. 17 is a schematic interaction diagram of a wireless communication method according to some embodiments of the present disclosure;

FIG. 18 is a schematic interaction diagram of a wireless communication method according to some embodiments of the present disclosure;

FIG. 19 is a schematic interaction diagram of a wireless communication method according to some embodiments of the present disclosure;

FIG. 20 is a schematic interaction diagram of a wireless communication method according to some embodiments of the present disclosure;

FIG. 21 is a schematic block diagram of a network device according to some embodiments of the present disclosure;

FIG. 22 is a schematic block diagram of a core network device according to some embodiments of the present disclosure;

FIG. 23 is a schematic block diagram of a core network device according to some embodiments of the present disclosure;

FIG. 24 is a schematic block diagram of a terminal device according to some embodiments of the present disclosure;

FIG. 25 is a schematic block diagram of a core network device according to some embodiments of the present disclosure;

FIG. 26 is a schematic block diagram of a communication device according to some embodiments of the present disclosure;

FIG. 27 is a schematic block diagram of a chip according to some embodiments of the present disclosure;

FIG. 28 is a schematic block diagram of a communication system according to some embodiments of the present disclosure; and

FIG. 29 is a schematic block diagram of another communication system according to some embodiments of the present disclosure.

### DETAILED DESCRIPTION

The technical solutions in the embodiments of the present disclosure are described below with reference to the accompanying drawings in the embodiments of the present disclosure. It is apparent that the described embodiments are merely some rather than all of the embodiments of the present disclosure. All other embodiments acquired by a person of ordinary skill in the art based on the embodiments of the present disclosure without creative efforts shall fall within the protection scope of the present disclosure.

The technical solutions in the embodiments of the present disclosure are applicable to various communication systems, such as a global system for mobile communications (GSM), a code division multiple access (CDMA) system, a wideband code division multiple access (WCDMA) system, a general packet radio system (GPRS), a long term evolution (LTE) system, an LTE-advanced (LTE-A) system, a new radio (NR) system, an evolved system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (Wi-Fi) network, a 5G communication system, or another communication system.

Generally, a conventional communication system supports a limited quantity of connections and is easy to implement. However, with development of communication technologies, a mobile communication system supports device-to-device (D2D) communication, machine-to-machine (M2M) communication, machine-type communication (MTC), vehicle-to vehicle-(V2V) communication, vehicle-to-everything (V2X) communication, and the like in addition to conventional communication. The embodiments of the present disclosure are also applicable to these communication systems.

Optionally, the communication system in the embodiments of the present disclosure is applicable to a carrier aggregation (CA) scenario, a dual connectivity (DC) scenario, or a standalone (SA) networking scenario.

Optionally, the communication system in the embodiments of the present disclosure is applicable to an unlicensed spectrum. The unlicensed spectrum is also considered as a shared spectrum. Alternatively, the communication system in the embodiments of the present disclosure is applicable to a licensed spectrum. The licensed spectrum is also considered as an unshared spectrum.

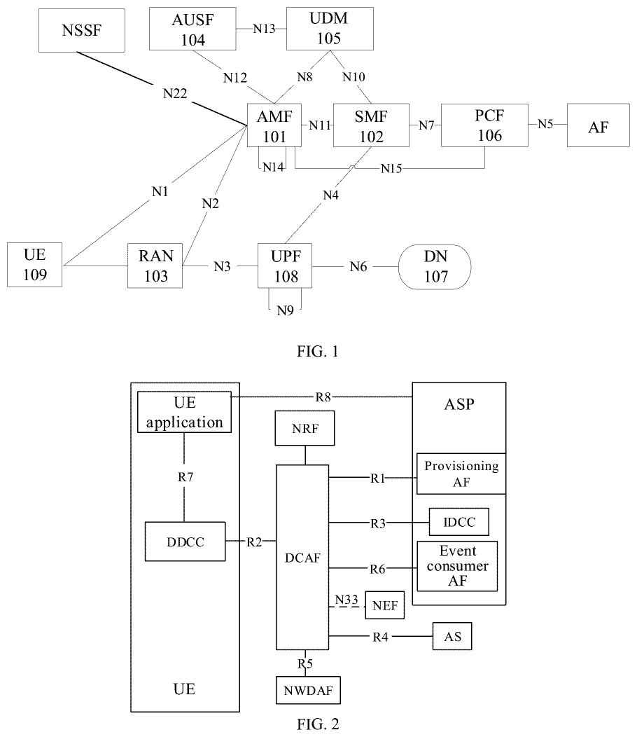

FIG. 1 is a schematic diagram of the architecture of a communication system according to some embodiments of the present disclosure. As shown in FIG. 1, the communication system includes an access and mobility management function (AMF) entity 101, a session management function (SMF) entity 102, a radio access network (RAN) 103, an authentication server function (AUSF) entity 104, a unified data management (UDM) entity 105, a policy control function (PCF) entity 106, a data network (DN) 107, a user plane function (UPF) entity 108, and user equipment (UE) 109.

The UE 109 is connected to the AMF entity 101 over an interface N1. The UE 109 is connected to the RAN 103 using a radio resource control (RRC) protocol. The RAN 103 is connected to the AMF entity 101 over an interface N2. The RAN 103 is connected to the UPF entity 108 over an interface N3. A plurality of UPF entities 108 are connected over an interface N9. The UPF entity 108 is connected to the DN 107 over an interface N6. The UPF entity 108 is connected to the SMF entity 102 over an interface N4. The SMF entity 102 is connected to the PCF entity 106 over an interface N7. The SMF entity 102 is connected to the UDM entity 105 over an interface N10. The SMF entity 102 is connected to the AMF entity 101 over an interface N11. A plurality of AMF entities 101 are connected over an interface N14. The AMF entity 101 is connected to the UDM entity 105 over an interface N8. The AMF entity 101 is connected to the AUSF entity 104 over an interface N12. The AMF entity 101 is connected to the PCF entity 106 over an interface N15. The AUSF entity 104 is connected to the UDM entity 105 over an interface N13. The AMF entity 101 and the SMF entity 102 acquire user subscription data from the UDM entity 105 over the interfaces N8 and N10 and policy data from the PCF entity 106 over the interfaces N15 and N7, respectively. The SMF entity 102 controls the UPF entity 108 over the interface N4.

The RAN 103 (referred to as an access network device) is an access device by which the UE 109 accesses the network architecture in a wireless manner, and is mainly responsible for radio resource management, quality of service (QoS) management, data compression, encryption, and the like on an air interface side.

In some embodiments of the present disclosure, the access network device is a device configured to communicate with a mobile device. The access network device is an access point (AP) in a WLAN, a base transceiver station (BTS) in a GSM or CDMA system, a NodeB (NB) in a WCDMA system, an evolved NodeB (eNB or eNodeB) in an LTE system, a relay station or an AP, a vehicle-mounted device, a wearable device, a gNodeB (gNB) in an NR network, an access network device in a future evolved public land mobile network (PLMN), an access network device in an NTN network, or the like.

By way of example but not limitation, in some embodiments of the present disclosure, the access network device has a mobile characteristic. For example, the access network device is a mobile device. Optionally, the access network device is a satellite or a balloon station. For example, the satellite is a low Earth orbit (LEO) satellite, a medium Earth orbit (MEO) satellite, a geostationary Earth orbit (GEO) satellite, a high elliptical orbit (HEO) satellite, or the like. Optionally, the access network device is alternatively a base station disposed on land, water, or the like.

In the embodiments of the present disclosure, the access network device provides services for a cell. A terminal device communicates with the access network device over transmission resources (for example, frequency domain resources or spectrum resources) used by the cell. The cell is a cell corresponding to the access network device (for example, a base station). The cell belongs to a macro base station or a base station corresponding to a small cell. The small cell includes a metro cell, micro cell, pico cell, femto cell, or the like. The small cell features small coverage and low transmission power and is suitable for providing high-rate data transmission services.

In some embodiments of the present disclosure, the AMF entity 101, SMF entity 102, AUSF entity 104, UDM entity 105, PCF entity 106, DN 107, and UPF entity 108 are network elements of a core network (core network elements for short).

The AMF network element is configured to manage access of a terminal to the core network, such as updating the location of the terminal, network registration, access control, mobility management on the terminal, attachment, and detachment of the terminal, and the like. When providing services for a session of the terminal, the AMF network element further provides control-plane storage resources for the session to store a session ID, an SMF network element ID associated with the session ID, and the like.

The SMF network element is configured to select a user-plane network element for the terminal, redirect a user-plane network element for the terminal, assign an Internet Protocol (IP) address to the terminal, establish a bearer (also referred to as a session) between the terminal and the UPF network element, modify and release a session, and control QoS.

The AUSF network element is configured to receive a request for identity authentication on the terminal from the AMF network element, request a key from the UDM network element, and forward the delivered key to the AMF network element for authentication.

The UDM network element implements functions such as generating and storing user subscription data and managing authentication data and supports interaction with an external third-party server. The PCF network element is configured to provide a QoS policy, a slice selection policy, or the like for the AMF network element and the SMF network element.

The DN provides a data service for a user on an IP multimedia service (IMS) network, the Internet, or the like. There are various application servers (ASs) in the DN, providing different application services, such as an operator service, Internet access, or a third-party service. The AS implements a function of an application function (AF) network element.

The UPF network element is mainly responsible for transmitting user data. Other network elements are referred to as control plane function network elements, mainly responsible for verification, authentication, registration management, session management, mobility management, policy control, and the like, to ensure reliable and stable transmission of user data.

The UPF network element is configured to forward and receive data from the terminal. For example, the UPF network element receives service data from the DN and sends the service data to the terminal by the access network device. The UPF network element also receives user data from the terminal by the access network device and forwards the user data to the DN. Transmission resources allocated and scheduled by the UPF network element for the terminal are managed and controlled by the SMF network element. The bearer between the terminal and the UPF network element includes a user plane connection between the UPF network element and the access network device, and a channel established between the access network device and the terminal. The user plane connection is a QoS flow that can establish data transmission between the UPF network element and the access network device.

The AF network element is configured to interact with the core network elements to support the routing of application impact data, access a network exposure function (NEF), interact with the PCF network element to perform policy control, and the like.

In some embodiments of the present disclosure, the UE is also referred to as a terminal device, an access terminal, a subscriber unit, a subscriber station, a mobile station, a mobile platform, a remote station, a remote terminal, a mobile device, a user terminal, a terminal, a wireless communication device, a user agent, a user apparatus, or the like.

The terminal device is a station in a WLAN; or is a cellular phone, a cordless phone, a Session Initiation Protocol (SIP) phone, a wireless local loop (WLL) station, a personal digital assistant (PDA), a handheld device with a wireless communication function, a computing device or another processing device connected to a wireless modem, a vehicle-mounted device, a wearable device, a terminal device in a next-generation communication system such as an NR network, a terminal device in a future evolved PLMN, or the like.

In the embodiments of the present disclosure, the terminal device is deployed on land, including indoor or outdoor, handheld, wearable, or vehicle-mounted; is deployed on water (such as a ship); or is deployed in the air (such as on an aircraft, a balloon, or a satellite).

In the embodiments of the present disclosure, the terminal device is a mobile phone, a tablet computer, a computer with a wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home, or the like.

By way of example but not limitation, in the embodiments of the present disclosure, the terminal device is alternatively a wearable device. The wearable device is also referred to as a wearable intelligent device. Wearable technology is used to intelligently design daily wear and develop wearable devices, such as glasses, a glove, a watch, clothing, or shoes. The wearable device is a portable device that is directly worn or integrated into a user's clothing or accessory. The wearable device is not only a hardware device, but also implements powerful functions through software support, data interaction, and cloud interaction. Generalized wearable intelligent devices include full-function and large-size devices that can achieve a complete or partial function without relying on smartphones, such as smart watches or smart glasses, and devices that focus on a specific type of AF and need to be used with smartphones or the like, such as various smart bands or smart jewelry used for sign monitoring.

It should be noted that the network architecture of the communication system shown in FIG. 1 does not constitute a limitation on the network architecture of the communication system in the embodiments of the present disclosure. In a specific implementation, the communication system alternatively includes more or fewer network elements than those shown in FIG. 1, combining some network elements, or the like. It should be understood that the RAN in FIG. 1 is alternatively represented by an access network (AN).

For example, the communication system shown in FIG. 1 further includes an NWDAF network element, a NEF network element, and the like, which is connected to other network elements in the communication system shown in FIG. 1 over corresponding interfaces. The NWDAF network element collects data from other core network elements, a network management system, or the like to perform big data statistics collection or analysis, or intelligent data analysis, acquires analytics or prediction data on a network side, and sends a data analytics result to each core network element, to assist each core network element in more effectively controlling access of the terminal device based on the analytics result. The NEF network element is configured to provide network capability and event exposure, and receive relevant external information.

It should be understood that in the embodiments of the present disclosure, devices with a communication function in a network/system are referred to as communication devices. For example, in the communication system shown in FIG. 1, communication devices include an access network device with a communication capability (such as the RAN 103), the core network elements (such as the PCF entity 106), and the UE 109.

It should be understood that the terms “system” and “network” in this specification can be exchanged. The term “and/or” in this specification merely describes an association relationship between associated objects, and indicates that three types of relationships exist. For example, A and/or B indicates that A exists alone, A and B coexist, or B exists alone. In addition, the character “/” in this specification generally indicates that the associated objects are in an “or” relationship.

It should be understood that the term “indication” mentioned in the embodiments of the present disclosure is a direct indication, an indirect indication, or an association relationship. For example, A indicates B, which means that A directly indicates B, for example, B is acquired through A; means that A indirectly indicates B, for example, A indicates C, and B is acquired through C; or means an association relationship between A and B.

In the description of the embodiments of the present disclosure, the term “corresponding” indicates a direct or indirect correspondence between two objects, an association relationship between the two objects, or a relationship between indication and being indicated, between configuration and being configured, or the like.

In the embodiments of the present disclosure, “predefinition” is implemented by pre-storing corresponding code or a corresponding table in a device (such as the terminal device or the network device) or through another method that can be used to indicate relevant information, and a specific implementation method thereof is not limited in the present disclosure. For example, a predefined thing is a thing defined in a protocol.

It should be understood that network devices in the embodiments of the present disclosure include an access network device and a core network device.

In the embodiments of the present disclosure, the “protocol” is a standard protocol in the communication field, for example, includes an LTE protocol, an NR protocol, and a related protocol applied in a future communication system. This is not limited in the present disclosure.

To facilitate understanding of the embodiments of the present disclosure, a DCAF architecture related to the present disclosure is described.

FIG. 2 is a schematic connection diagram of a DCAF architecture. A DCAF network element provides data collection and reporting services, and can meet the need of the NWDAF network element to directly or indirectly collect data from the UE for analysis. Another AF network element (for example, inside or outside the 5G system) further subscribes to services of the DCAF network element to collect some application layer data required by the AF network element from the UE. The DCAF network element is deployed inside or outside a trusted domain. Functions of each network element in FIG. 2 are as follows.

For each event that needs to be provided to an event consumer, a provisioning AF network element sends a set of configuration information to the DCAF network element. The configuration information includes configuration parameters such as an event ID that needs to be provided, an external application ID used by a data collection client to report data to the DCAF network element, an internal application ID corresponding to the consumer that subscribes to the event from the DCAF network element, parameters reported by the UE to the DCAF network element, and how to process collected data. Based on the configuration information, the DCAF network element provides data collection and reporting configurations to a direct data collection client (DDCC) or an indirect data collection client (IDCC) through reference points R2 and R3, and receives data reported by the UE through the reference points R2 and R3. The data collection and reporting configurations include the external application ID and parameters that need to be collected.

The DDCC is responsible for collecting relevant data within the UE and reporting the data to the DCAF network element through the reference point R2. An application service provider (ASP) collects data from a UE application through a reference point R8 and sends the data to the DCAF network element via the IDCC through the reference point R3.

An application service (AS) instance inside or outside the trusted domain also collects data and reports the data to the DCAF network element through a reference point R4.

The NWDAF network element serves as a consumer. After processing the collected data, the DCAF network element sends processed data to the NWDAF network element through a reference point R5 for subsequent analysis by the NWDAF network element.

With corresponding data collection and reporting configurations, the UE data collected by the DCAF network element is also provided to an event consumer AF through a reference point R6.

To facilitate understanding of the technical solutions in the embodiments of the present disclosure, federal learning (FL) related to the present disclosure is described.

As camera and sensor performance of a mobile terminal continuously improves, an increasing quantity of terminals can collect valuable training data necessary for AI or ML model training. For many AI tasks or ML tasks, small sample training data collected by the mobile terminal is of great significance for training a global model.

FL is a machine learning architecture, in which a terminal device can train a global model based on small sample training data (or a subset of training data) to acquire a local training result. For example, the terminal device can input the small sample training data to the global model (such as a deep neural network (DNN)) to acquire an intermediate training result (or the local training result), such as gradient information of the DNN. An FL server can complete training of the global model by aggregating local training results reported by a plurality of terminal devices.

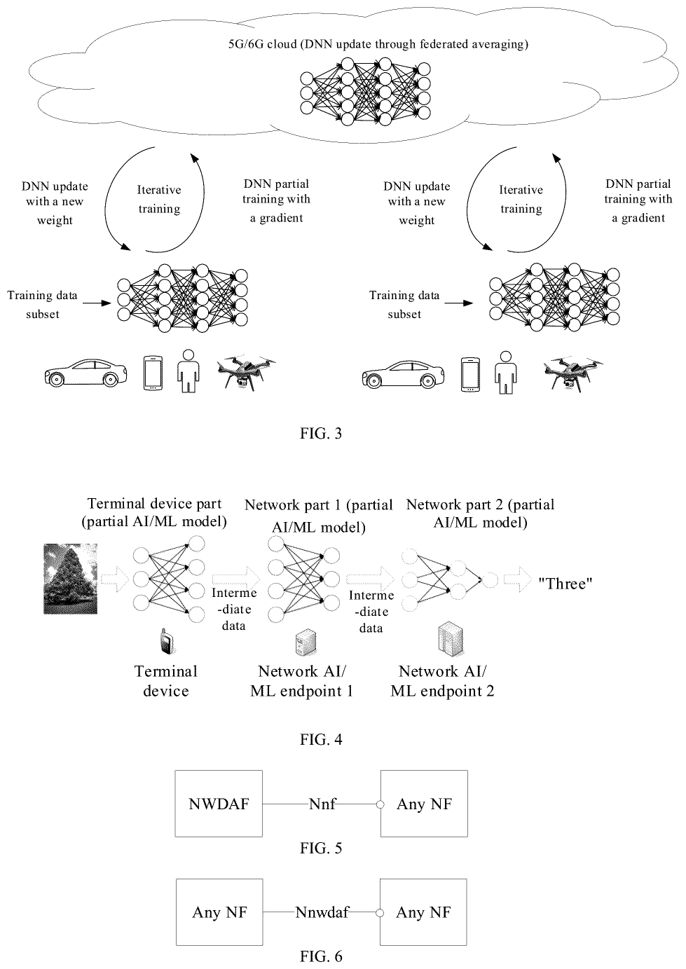

FIG. 3 is a diagram of an FL architecture. In each iterative training, the terminal device trains, over local training data, the global model downloaded from the FL server, and then reports the intermediate training result (such as the gradient information of the DNN) to the FL server over an uplink channel. Then, the FL server aggregates the collected gradient information and updates the global model. The FL server distributes, over a downlink channel, an updated global model to the terminal devices participating in FL. The terminal devices perform next iterative training on the updated model.

To facilitate understanding of the technical solutions in the embodiments of the present disclosure, model splitting related to the present disclosure is described.

FIG. 4 shows a solution for splitting AI/ML inference. An AI/ML operation or model is split into a plurality of parts based on a current AI/ML task and work environment. Its purpose is to transfer computing that consumes much computing power and energy to a network-side node, while computing that is sensitive to latency and needs to remain on the terminal device under specific privacy protection rules remains on the terminal device. A terminal device executes the AI/ML operation until a specific part or the AI/ML model (such as a neural network) until a specific layer, and sends generated intermediate data to a network. The network-side node is responsible for executing the remaining part of the AI/ML operation or the remaining layers of the AI/ML model, and feeding back an inference result to the terminal device. It should be noted that in an example shown in FIG. 4, a final inference result is output by a network-side AI/ML endpoint 2. In an actual use case, the inference result is alternatively output by another endpoint, such as a network-side AI/ML endpoint 1. This is not limited in the present disclosure.

To limit a required uplink data rate, a potential split point is set after a pooling layer that outputs a small amount of data. In general, the more front the split point, the smaller the computing amount of the terminal device; and the more rear the split point, the lower the required data transmission rate.

To facilitate understanding of the embodiments of the present disclosure, the NWDAF network element related to the present disclosure is described.

In some scenarios, the NWDAF network element is added to a core network of a 5G network. It collects data from each core network element, a network management system, or the like to perform big data statistics collection or analysis, or intelligent data analysis and acquire analytics or prediction data on a network side, to assist each core network element in more effectively controlling UE access based on a data analytics result. Specifically, the NWDAF network element collects data from other core network elements for big data analysis. In view of this, an interface between the NWDAF network element and another network function (NF) network element is defined. For example, the NWDAF network element requests collected data from the NF network element over the interface (as shown in FIG. 5). For another example, the NF network element requests an analytics result from the NWDAF network element over the interface (as shown in FIG. 6). The NWDAF network element can provide various analytics results, which have great significance for the UE. For example, the analytics results can assist the UE in deciding on an AI operation and improve the performance of an AI system. Therefore, how to expose information to a terminal device is an urgent problem to be resolved.

For ease of understanding of the technical solutions in the embodiments of the present disclosure, the technical solutions in the present disclosure are described in detail below with specific embodiments. The related art described above, as optional solutions, is arbitrarily combined with the technical solutions in the embodiments of the present disclosure, and all fall within the protection scope of the embodiments of the present disclosure. The embodiments of the present disclosure include at least part of the following content.

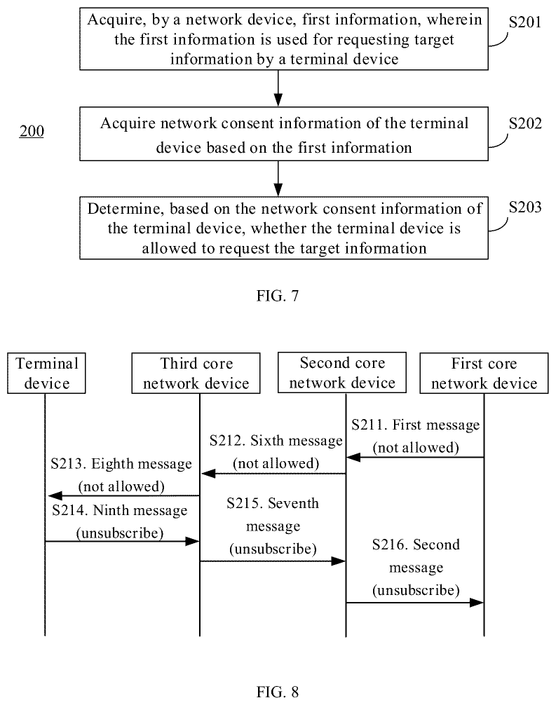

FIG. 7 is a schematic diagram of a wireless communication method 200 according to some embodiments of the present disclosure. As shown in FIG. 7, the method 200 includes at least part of the following content:

In S210, a network device acquires first information. The first information is used for requesting target information by a terminal device.

In S220, network consent information of the terminal device is acquired based on the first information.

In S230, it is determined, based on the network consent information of the terminal device, whether the terminal device is allowed to request the target information.

In some embodiments, the network device is a core network element.

In some embodiments, the network device is an existing core network element, such as an NWDAF entity or a NEF entity. For example, a function for verifying the network consent information of the terminal device is added to the existing core network element.

In some embodiments, the network device is alternatively a newly added core network element. For example, the newly added core network element is configured to verify the network consent information of the terminal device.

In some embodiments, the target information is considered as information that the terminal device requests to expose, information that the terminal device wants to acquire, or information to which the terminal device wants to subscribe.

In some embodiments, the target information includes any information acquired from each core network element, a network management system, or the like. This is not limited in the present disclosure.

By way of example but not limitation, the target information includes, but is not limited to, at least one of the following:
analytics information, access management information of the terminal device, or session information of the terminal device.

In some embodiments, the analytics information is analytics result information, for example, includes analytics result information provided by the NWDAF entity.

In some embodiments, the analytics information includes, but is not limited to, at least one of the following:
network performance information, UE mobility information, user data congestion information, or QoS sustainability information.

In some embodiments, the network performance information is acquired by performing statistics collection and prediction on network load information in a region of interest. The network performance information further counts and predicts a UE quantity in the region of interest.

In some embodiments, the UE mobility information is acquired by performing statistics collection or prediction on UE mobility.

In some embodiments, the user data congestion information is statistics or predictions about user data congestion, for example, including transmissions for a user plane and/or transmissions for a control plane.

In some embodiments, the QoS sustainability information is statistical information about QoS, for example, including a position, time, and threshold exceeded when the QoS changes; or predictive information about QoS, for example, a position and time of a potential QoS change and a threshold that is exceeded.

In some embodiments, the first information includes identification information of the target information, indicating the target information requested by the terminal device, for example, the analytics information, the access management information of the terminal device, and the session information of the terminal device.

In some embodiments, the first information includes requester information of the target information, such as identification information of the terminal device requesting the target information; and information about an application requesting the target information on the terminal device, such as an ID of the application requesting the target information on the terminal device.

In some embodiments, the first information includes other parameter information of the target information, such as time information and address information. For example, the terminal device requests to acquire target information within a specific time period (such as a time period in the past or in the future), or the terminal device requests target information for notifying a specific target address.

By way of example but not limitation, the first information includes, but is not limited to, at least one of the following:
identification information of the terminal device, used for identifying the terminal device;
identification information of the target information, used for identifying the target information;
an application identifier (ID) used for identifying an application requesting the target information on the terminal device;
an analytics ID corresponding to the target information;
target time information corresponding to the target information; or
target address information corresponding to the target information.

In some embodiments, the identification information of the terminal device includes, but is not limited to, a subscription permanent identifier (SUPI) or a generic public subscription identifier (GPSI) of the terminal device.

In some embodiments, the identification information of the terminal device is acquired based on internet protocol (IP) address information of the terminal device.

In some embodiments, the application ID is used for identifying which application on the terminal device requests the target information.

For example, if a first application on the terminal device requests the target information, the application ID is an ID of the first application.

In some embodiments, the analytics ID corresponding to the target information is used for identifying an analytics information type corresponding to the target information.

For example, if the target information is the network performance information, the analytics ID corresponding to the target information is Network Performance.

For another example, if the target information is the UE mobility information, the analytics ID corresponding to the target information is UE Mobility.

For another example, if the target information is the user data congestion information, the analytics ID corresponding to the target information is User Data Congestion.

For another example, if the target information is the QoS sustainability information, the analytics ID corresponding to the target information is QoS Sustainability.

In some embodiments, the target time information corresponding to the target information indicates a target time period of the target information requested by the terminal device. In other words, the terminal device requests to acquire target information within the time period indicated by the target time information.

For example, the target time information corresponding to the target information includes start time information and/or end time information of the target information, or start time information and duration information of the target information.

In some embodiments, the target time information corresponding to the target information is historical time information or future time information. In other words, the target time information indicates a time period in the past or in the future.

In some embodiments, the target address information corresponding to the target information is a target address at which notification of the target information is given. That is, a device corresponding to the target address information has permission to acquire the target information.

In some embodiments, the target address information is IP address information, media access control (MAC) address information, or the like.

It should be understood that the foregoing content of the first information is merely an example. In practical application, the first information further includes other parameter information for acquiring the target information. The present disclosure is not limited thereto.

In some embodiments, the network consent information of the terminal device indicates permission of exposing information to the terminal device or permission of a network to agree to expose information to the terminal device, for example, includes whether the terminal device is allowed by the network to acquire information (or whether the network agrees to expose information to the terminal device), information that the terminal device is allowed to acquire by the network (or information that the network agrees to expose to the terminal device), and information that the terminal device is not allowed to acquire by the network (or information that the network does not agree to expose to the terminal device).

In some embodiments, the network consent information of the terminal device is considered as a type of subscription information of the terminal device.

In some embodiments, a granularity of the network consent information of the terminal device includes at least one of the following:
per terminal device, per information type, per analytics ID, or per application ID.

For example, the network consent information of the terminal device indicates whether the network agrees to expose information to the terminal device. The information is any information.

For another example, the network consent information of the terminal device indicates the information that the network agrees or does not agree to expose to the terminal device.

For another example, the network consent information of the terminal device indicates an analytics ID corresponding to the information that the network agrees or does not agree to expose to the terminal device.

For another example, the network consent information of the terminal device indicates an ID of an application requesting the information that the network agrees or does not agree to expose to the terminal device.

In some embodiments, the network consent information of the terminal device is alternatively of another parameter granularity, for example, per time period or per target address, such as allowing or not allowing the terminal device to request target information within a specific time period, or allowing or not allowing the terminal device to request target information for a specific target address.

By way of example but not limitation, the network consent information of the terminal device includes, but is not limited to, at least one of the following:
information indicating whether the terminal device is allowed to request information;
information that the terminal device is allowed to request;
information that the terminal device is not allowed to request;
an analytics ID corresponding to the information that the terminal device is allowed to request;
an analytics ID corresponding to the information that the terminal device is not allowed to request;
an application ID of the information that the terminal device is allowed to request;
an application ID of the information that the terminal device is not allowed to request;
time information corresponding to the information that the terminal device is allowed to request;
time information corresponding to the information that the terminal device is not allowed to request;
address information corresponding to the information that the terminal device is allowed to request; or
address information corresponding to the information that the terminal device is not allowed to request.

In some embodiments, information indicating whether the terminal device is allowed to request information is network consent information at a granularity of per terminal device, regardless of a type of the requested information, an application ID of the requested information, an analytics ID corresponding to the requested information, and the like.

For example, if the terminal device is not allowed to request information, the terminal device is not allowed to request information of all analytics IDs, or an application with any ID on the terminal device is not allowed to request information.

For another example, if the terminal device is allowed to request information, the terminal device is allowed to request information of all analytics IDs, or an application with any ID on the terminal device is allowed to request information.

In some embodiments, the information that the terminal device is allowed to request and the information that the terminal device is not allowed to request is considered as network consent information at a granularity of per information type.

For example, the information that the terminal device is allowed to request includes the analytics information. If the target information requested by the terminal device is the access management information, the request of the terminal device is not allowed.

For another example, the information that the terminal device is not allowed to request includes the analytics information. If the target information requested by the terminal device is the access management information, the request of the terminal device is allowed.

In some embodiments, the analytics ID corresponding to the information that the terminal device is allowed to request and the analytics ID corresponding to the information that the terminal device is not allowed to request is network consent information at a granularity of per analytics ID.

For example, the analytics ID corresponding to the information that the terminal device is allowed to request includes a first analytics ID, indicating that the terminal device is allowed to request analytics information corresponding to the first analytics ID. If the analytics ID corresponding to the target information requested by the terminal device is a second analytics ID, the request of the terminal device is not allowed.

For another example, the analytics ID corresponding to the information that the terminal device is not allowed to request includes the second analytics ID, indicating that the terminal device is not allowed to request analytics information corresponding to the second analytics ID. If the analytics ID corresponding to the target information requested by the terminal device is the first analytics ID, the request of the terminal device is allowed.

In some embodiments, the application ID of the information that the terminal device is allowed to request and the application ID of the information that the terminal device is not allowed to request is network consent information at a granularity of per application ID.

For example, the application ID of the information that the terminal device is allowed to request includes the ID of the first application, indicating that the first application on the terminal device is allowed to request information. If a second application on the terminal device requests information, the request of the terminal device is not allowed.

For another example, the application ID of the information that the terminal device is not allowed to request includes an ID of the second application, indicating that the second application on the terminal device is not allowed to request information. If the first application on the terminal device requests information, the request of the terminal device is allowed.

In some embodiments, the time information of the information that the terminal device is allowed to request and the time information of the information that the terminal device is not allowed to request is network consent information at a granularity of per time period.

For example, the time information of the information that the terminal device is allowed to request corresponds to a first time period, indicating that the terminal device is allowed to request target information within a first time period. If the terminal device requests target information within a second time period, the request of the terminal device is not allowed.

For another example, the time information of the information that the terminal device is not allowed to request corresponds to the second time period, indicating that the terminal device is not allowed to request the target information within the second time period. If the terminal device requests the target information within the first time period, the request of the terminal device is allowed.

In some embodiments, the address information of the information that the terminal device is allowed to request and the address information of the information that the terminal device is not allowed to request is network consent information at a granularity of per target address.

For example, the address information of the information that the terminal device is allowed to request corresponds to a first target address, indicating that the terminal device is allowed to request the target information for the first target address. If the terminal device requests the target information for a second target address, the request of the terminal device is not allowed.

For another example, the address information of the information that the terminal device is not allowed to request corresponds to the second target address, indicating that the terminal device is not allowed to request the target information for the second target address. If the terminal device requests the target information for the first target address, the request of the terminal device is allowed.

In some embodiments of the present disclosure, if the network device determines that the terminal device is not allowed to request the target information, that is, the network does not agree to the request of the terminal device (or network consent fails), the network device notifies the terminal device that the terminal device is not allowed to request the target information (or the network consent fails). For example, the network device notifies the terminal device via another network device that the terminal device is not allowed to request the target information (or the network consent fails).

Further, when knowing that the network consent fails, the terminal device cancels the request for the target information. For example, the terminal device notifies the network device that the request for the target information is canceled. Specifically, the terminal device notifies the network device via another network device that the request for the target information is canceled.

In some embodiments of the present disclosure, if the network device determines that the terminal device is allowed to request the target information, that is, the network agrees to the request of the terminal device (or network consent is successful), the network device acquires the target information and sends the target information to the terminal device. For example, the target information is sent to the terminal device via another network device.

In some embodiments, that the network device acquires the target information includes the following content.

If the network device is a device providing the target information, the network device generates the target information.

For example, if the target information is the analytics information and the network device is an NWDAF entity, the network device generates the analytics information.

In some other embodiments, that the network device acquires the target information includes the following content.

If the network device is not a device providing the target information, the network device acquires the target information from a device providing the target information.

For example, if the target information is the access management information of the terminal device, the network device acquires the access management information of the terminal device from an AMF entity.

For another example, if the target information is the session information of the terminal device, the network device acquires the session information of the terminal device from an SMF entity.

With reference to Embodiment 1 and Embodiment 2, a specific implementation process of the embodiments of the present disclosure is described below by using an example in which the network device is respectively a first core network device and a second core network device. The present disclosure is not limited thereto.

Embodiment 1: The network device is the first core network device.

In some embodiments, the first information is acquired from the second core network device.

In some embodiments, the first core network device is an NWDAF entity.

In some embodiments, the second core network device is a function entity configured to expose network information.

For example, the second core network device is a NEF entity or a newly defined network function entity dedicated to exposing relevant network information to UE, for example, the target information requested by the terminal device.

In some embodiments, if the second core network device is a NEF entity, the first information is sent over an existing message or service between the NEF entity and the NWDAF entity, or a new message or service is added for the terminal device to request information exposure.

In some embodiments, the first information is sent over nwdaf_AnalyticsSubscription_Subscribe.

In some embodiments, if the second core network device is a newly defined network function entity, a message or service is newly defined for the terminal device to request information exposure. That is, the first information is sent over the newly defined message or service.

In some embodiments, the first information is transmitted over an existing interface or a newly added interface between the first core network device and the second core network device.

Case 1: The network does not agree to the request of the terminal device, that is, the terminal device is not allowed to request the target information, or the network consent fails.

In some embodiments of the present disclosure, as shown in FIG. 8, the method 200 further includes:

In S211, the first core network device sends a first message to the second core network device in response to determining that the terminal device is not allowed to request the target information. The first message indicates that the terminal device is not allowed to request the target information.

In some embodiments, if the second core network device is a NEF entity, the first message is implemented by an existing message or service between the NWDAF entity and the NEF entity, or a new message or service is added to give notification of a verification result of the network consent information of the terminal device.

In some embodiments, the first message is implemented by Nnwdaf_AnalyticsSubscription_Notify.

In some embodiments, if the second core network device is a newly defined network function entity, a message or service is newly defined to give notification of a verification result of the network consent information of the terminal device. That is, the first message is a newly defined message or service.

In some embodiments, the first message is transmitted over an existing interface or a newly added interface between the first core network device and the second core network device.

In some embodiments, the first message includes indication information or a network consent failure parameter indicating that the terminal device is not allowed to request the target information.

In some embodiments, the first message further indicates a reason why the terminal device is not allowed to acquire the target information. For example, the terminal device is not allowed to acquire information, the terminal device is not allowed to acquire information of a specific analytics ID, an application with a specific ID on the terminal device is not allowed to request the target information, the terminal device is not allowed to request the time information corresponding to the target information, or address information of the terminal device is not included in the target address information corresponding to the target information.

In some embodiments, the first message further indicates at least one of the following:
the identification information of the terminal device, used for identifying the terminal device;
the identification information of the target information, used for identifying the target information;
the application ID used for identifying the application requesting the target information on the terminal device; or
the analytics ID corresponding to the target information.

Further, in some embodiments, the second core network device notifies the terminal device of the verification result of the network consent information of the terminal device. For example, the second core network device notifies the terminal device of the verification result of the network consent information of the terminal device via a third core network device.

In some embodiments of the present disclosure, as shown in FIG. 8, the method 200 further includes:

In S212, the second core network device sends a sixth message to the third core network device. The sixth message indicates that the terminal device is not allowed to request the target information.

In S213, the third core network device sends an eighth message to the terminal device. The eighth message indicates that the terminal device is not allowed to request the target information.

In some embodiments, the sixth message includes indication information or a network consent failure parameter indicating that the terminal device is not allowed to request the target information.

In some embodiments, the sixth message further indicates a reason why the terminal device is not allowed to acquire the target information. For example, the terminal device is not allowed to acquire information, the terminal device is not allowed to acquire information of a specific analytics ID, an application with a specific ID on the terminal device is not allowed to request the target information, the terminal device is not allowed to request the time information corresponding to the target information, or address information of the terminal device is not included in the target address information corresponding to the target information.

In some embodiments, the sixth message further indicates at least one of the following:
the identification information of the terminal device, used for identifying the terminal device;
the identification information of the target information, used for identifying the target information;
the application ID used for identifying the application requesting the target information on the terminal device; or
the analytics ID corresponding to the target information.

In some embodiments, the eighth message includes indication information or a network consent failure parameter indicating that the terminal device is not allowed to request the target information.

In some embodiments, the eighth message further indicates a reason why the terminal device is not allowed to acquire the target information. For example, the terminal device is not allowed to acquire information, the terminal device is not allowed to acquire information of a specific analytics ID, an application with a specific ID on the terminal device is not allowed to request the target information, the terminal device is not allowed to request the time information corresponding to the target information, or address information of the terminal device is not included in the target address information corresponding to the target information.

In some embodiments, the eighth message further indicates at least one of the following:
the identification information of the terminal device, used for identifying the terminal device;
the identification information of the target information, used for identifying the target information;
the application ID used for identifying the application requesting the target information on the terminal device; or
the analytics ID corresponding to the target information.

In some embodiments, the third core network device is an AF entity, such as a DCAF entity.

In some embodiments, if the second core network device is a NEF entity, the sixth message is implemented by an existing message or service between the NEF entity and the DCAF entity, or a new message or service is added to give notification of the verification result of the network consent information of the terminal device.

In some embodiments, the sixth message is implemented by Nnef_AnalyticsSubscription_Notify.

In some embodiments, if the second core network device is a newly defined network function entity, a message or service is newly defined to give notification of the verification result of the network consent information of the terminal device. That is, the sixth message is a newly defined message or service.

In some embodiments, the sixth message is transmitted over an existing interface or a newly added interface between the second core network device and the third core network device.

In some embodiments, the eighth message is transmitted over an established connection between the DCAF entity and the terminal device.

In some embodiments, the eighth message is HTTP signaling.

In some embodiments of the present disclosure, as shown in FIG. 8, the method 200 further includes:

In S214, after knowing that the request for the target information is not allowed, the terminal device sends a ninth message to the third core network device. The ninth message indicates that the terminal device cancels the request for the target information, that is, unsubscribes from the target information.

In S215, the third core network device sends a seventh message to the second core network device. The seventh message indicates that the terminal device cancels the request for the target information, that is, unsubscribes from the target information.

After receiving the seventh message, the second core network device sends a second message to the first core network device to indicate that the request for the target information is canceled, that is, the target information is unsubscribed from.

In some embodiments, if the second core network device is a NEF entity, the seventh message is implemented by an existing message or service between the NEF entity and the DCAF entity, or a new message or service is added to cancel the request of the terminal device for information exposure.

In some embodiments, the seventh message is implemented by Nnef_AnalyticsSubscription_UnSubscribe.

In some embodiments, if the second core network device is a newly defined network function entity, a message or service is newly defined to cancel the request of the terminal device for information exposure. That is, the seventh message is a newly defined message or service.

In some embodiments, the seventh message is transmitted over an existing interface or a newly added interface between the second core network device and the third core network device.

In some embodiments, the ninth message is transmitted over an established connection between the DCAF entity and the terminal device.

In some embodiments, the ninth message is HTTP signaling.

In some embodiments of the present disclosure, as shown in FIG. 8, the method 200 further includes:

In S216, the first core network device receives the second message from the second core network device. The second message indicates that the terminal device cancels the request for the target information, that is, unsubscribes from the target information.

In some embodiments, if the second core network device is a NEF entity, the second message is implemented by an existing message or service between the NWDAF entity and the NEF entity, or a new message or service is added to cancel the request of the terminal device for information exposure.

In some embodiments, the second message is implemented by Nnwdaf_AnalyticsSubscription_UnSubscribe.

In some embodiments, if the second core network device is a newly defined network function entity, a message or service is newly defined to cancel the request of the terminal device for information exposure. That is, the second message is a newly defined message or service.

In some embodiments, the second message is transmitted over an existing interface or a newly added interface between the first core network device and the second core network device.

Case 2: The network agrees to the request of the terminal device, that is, the terminal device is allowed to request the target information, or the network consent is successful.

In some embodiments of the present disclosure, the method 200 further includes:

The first core network device sends the target information to the second core network device in response to determining that the terminal device is allowed to request the target information and the target information is provided by the first core network device.

In some embodiments, the NWDAF entity provides the analytics information to the terminal device if the terminal device requests the analytics information. For example, the NWDAF entity sends the analytics information to the terminal device via the second core network device and a third core network device.

Specifically, the NWDAF entity sends the analytics information to the NEF entity. For example, the NWDAF entity sends the analytics information over Nnwdaf_AnalyticsSubscription_Notify.

Further, the NEF entity sends the analytics information to a DCAF entity. For example, the NEF entity sends the analytics information over Nnef_AnalyticsSubscription_Notify.

Then, the DCAF entity sends the analytics information to the terminal device, for example, over HTTP signaling.

In some embodiments of the present disclosure, the method 200 further includes:

In response to determining that the terminal device is allowed to request the target information, the first core network device acquires the target information from the device providing the target information.

For example, if the target information is the access management information of the terminal device, the first core network device acquires the access management information of the terminal device from an AMF entity.

For another example, if the target information is the session information of the terminal device, the first core network device acquires the session information of the terminal device from an SMF entity.

Further, the first core network device sends the target information to the terminal device via the second core network device and the third core network device.

Specifically, the NWDAF entity sends the target information to the NEF entity. For example, the NWDAF entity sends the target information over Nnwdaf_AnalyticsSubscription_Notify.

Further, the NEF entity sends the target information to a DCAF entity. For example, the NEF entity sends the target information over Nnef_AnalyticsSubscription_Notify.

Then, the DCAF entity sends the target information to the terminal device, for example, over HTTP signaling.

Embodiment 2: The network device is the second core network device.

In some embodiments, the first information is acquired from a third core network device.

In some embodiments, the second core network device is a function entity configured to expose network information.

For example, the second core network device is a NEF entity or a newly defined network function entity dedicated to exposing relevant network information to UE, for example, the target information requested by the terminal device.

In some embodiments, the third core network device is an AF entity, such as a DCAF entity.

In some embodiments, if the second core network device is a NEF entity, the first information is sent over an existing message or service between the NEF entity and the DCAF entity, or a new message or service is added for the terminal device to request information exposure.

In some embodiments, the first information is sent over Nnef_EventExposure_Subscribe.

In some embodiments, if the second core network device is a newly defined network function entity, a message or service is newly defined for the terminal device to request information exposure. That is, the first information is sent over the newly defined message or service.

In some embodiments, the first information is transmitted over an existing interface or a newly added interface between the second core network device and the third core network device.

Case 1: The network does not agree to the request of the terminal device, that is, the terminal device is not allowed to request the target information, or the network consent fails.

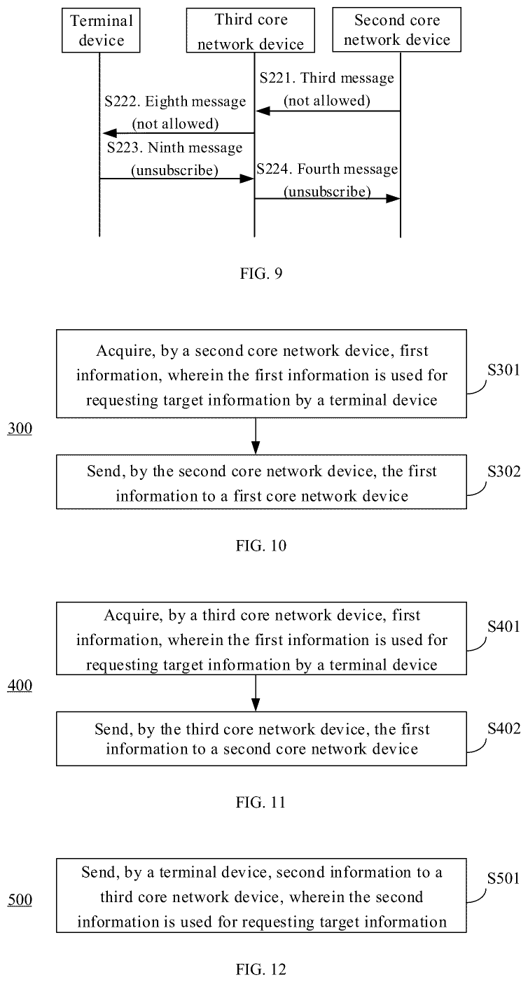

In some embodiments of the present disclosure, as shown in FIG. 9, the method 200 further includes the following processes.

In S221, the second core network device sends a third message to the third core network device in response to determining that the terminal device is not allowed to request the target information. The third message indicates that the terminal device is not allowed to request the target information.

In some embodiments, if the second core network device is a NEF entity, the third message is implemented by an existing message or service between the NEF entity and the DCAF entity, or a new message or service is added to give notification of a verification result of the network consent information of the terminal device.

In some embodiments, the third message is implemented by Nnef_EventExposure_Notify.

In some embodiments, if the second core network device is a newly defined network function entity, a message or service is newly defined to give notification of the verification result of the network consent information of the terminal device. That is, the third message is a newly defined message or service.

In some embodiments, the third message is transmitted over an existing interface or a newly added interface between the second core network device and the third core network device.

In some embodiments, the third message includes indication information or a network consent failure parameter indicating that the terminal device is not allowed to request the target information.

In some embodiments, the third message indicates a reason why the terminal device is not allowed to acquire the target information. For example, the terminal device is not allowed to acquire information, the terminal device is not allowed to acquire information of a specific analytics ID, an application with a specific ID on the terminal device is not allowed to request the target information, the terminal device is not allowed to request the time information corresponding to the target information, or address information of the terminal device is not included in the target address information corresponding to the target information.

In some embodiments, the third message indicates at least one of the following:
the identification information of the terminal device, used for identifying the terminal device;
the identification information of the target information, used for identifying the target information;
the application ID used for identifying the application requesting the target information on the terminal device; or
the analytics ID corresponding to the target information.

In some embodiments, as shown in FIG. 9, the method 200 further includes:

In S222, the third core network device notifies the terminal device of the verification result of the network consent information of the terminal device. For example, the third core network device sends an eighth message to the terminal device. The eighth message indicates that the terminal device is not allowed to request the target information.

In some embodiments, the eighth message includes indication information or a network consent failure parameter indicating that the terminal device is not allowed to request the target information.

In some embodiments, the eighth message further indicates a reason why the terminal device is not allowed to acquire the target information. For example, the terminal device is not allowed to acquire information, the terminal device is not allowed to acquire information of a specific analytics ID, an application with a specific ID on the terminal device is not allowed to request the target information, the terminal device is not allowed to request the time information corresponding to the target information, or address information of the terminal device is not included in the target address information corresponding to the target information.

In some embodiments, the eighth message further indicates at least one of the following:
the identification information of the terminal device, used for identifying the terminal device;
the identification information of the target information, used for identifying the target information;
the application ID used for identifying the application requesting the target information on the terminal device; or
the analytics ID corresponding to the target information.

In some embodiments, the eighth message is transmitted by an established connection between the DCAF entity and the terminal device.

In some embodiments, the eighth message is HTTP signaling.

In some embodiments of the present disclosure, as shown in FIG. 9, the method 200 further includes:

In S223, after knowing that the request for the target information is not allowed, the terminal device sends a ninth message to the third core network device. The ninth message indicates that the terminal device cancels the request for the target information, that is, unsubscribes from the target information.

In some embodiments, the ninth message is transmitted by an established connection between the DCAF entity and the terminal device.

In some embodiments, the ninth message is HTTP signaling.

In some embodiments of the present disclosure, as shown in FIG. 9, the method 200 further includes:

In S224, the second core network device receives a fourth message from the third core network device. The fourth message indicates that the terminal device cancels the request for the target information.

Specifically, after receiving the ninth message, the third core network device sends the fourth message to the second core network device. The fourth message indicates that the terminal device cancels the request for the target information, that is, unsubscribes from the target information.

In some embodiments, if the second core network device is a NEF entity, the fourth message is implemented by an existing message or service between the NEF entity and the DCAF entity, or a new message or service is added to cancel the request of the terminal device for information exposure.

In some embodiments, the fourth message is implemented by Nnef_EventExposure_Unsubscribe.

In some embodiments, if the second core network device is a newly defined network function entity, a message or service is newly defined to cancel the request of the terminal device for information exposure. That is, the fourth message is a newly defined message or service.

In some embodiments, the fourth message is transmitted over an existing interface or a newly added interface between the second core network device and the third core network device.

In some embodiments of the present disclosure, the method 200 further includes:

The second core network device sends a fifth message to a fourth core network device in response to determining that the terminal device is allowed to request the target information. The fifth message is used for requesting the fourth core network device to provide the target information.

The second core network device receives the target information from the fourth core network device.

In some embodiments, the fourth core network device is a device providing the target information.

For example, the target information is the access management information of the terminal device, and the fourth core network device is an AMF entity.

For another example, the target information is the session information of the terminal device, and the fourth core network device is an SMF entity.

For another example, the target information is the analytics information, and the fourth core network device is an NWDAF entity.

In some embodiments of the present disclosure, the method 200 further includes:

The second core network device sends the target information to the third core network device.

The third core network device sends the target information to the terminal device.

For example, the target information is sent by an existing message or service between the second core network device and the third core network device, or a new message or service is added to send the target information.

As an example, the target information is sent by Nnef_EventExposure_Notify.

For example, the target information is transmitted by an established connection between the third core network device and the terminal device.

As an example, the target information is sent by HTTP signaling.

In some embodiments of the present disclosure, the network consent information of the terminal device is acquired from a fifth core network device.

For example, the fifth core network device is a UDM entity.

Therefore, in the embodiments of the present disclosure, the network consent information of the terminal device is stored in the UDM entity as subscription information of the terminal device. Further, when the terminal device requests to expose the target information, the network device acquires the network consent information from the UDM entity, and verifies information exposure permission of the terminal device.

In some embodiments of the present disclosure, that the network consent information of the terminal device is acquired based on the first information includes the following content.

The network device sends the first information to the fifth core network device.

The network device receives the network consent information of the terminal device from the fifth core network device.

For example, the network device is the first core network device. The first core network device sends the first information to the fifth core network device, and further receives the network consent information of the terminal device from the fifth core network device.

For another example, the network device is the second core network device. The second core network device sends the first information to the fifth core network device, and further receives the network consent information of the terminal device from the fifth core network device.

In some embodiments, if the first core network device is an NWDAF entity, the first information is sent over an existing message or service between the NWDAF entity and the UDM entity, or a new message or service is added for the terminal device to request information exposure. For example, the first information is sent by Nudm_SDM_Subscribe.

In some embodiments, if the first core network device is an NWDAF entity, the network consent information of the terminal device is sent over an existing message or service between the NWDAF entity and the UDM entity, or a new message or service is added to give notification of the network consent information of the terminal device. For example, the network consent information of the terminal device is sent by Nudm_SDM_Notification.

In some embodiments, if the second core network device is a NEF entity, the first information is sent over an existing message or service between the NWDAF entity and the NEF entity, or a new message or service is added for the terminal device to request information exposure. For example, the first information is sent over Nudm_SDM_Subscribe.

In some embodiments, if the second core network device is a newly defined network function entity, a message or service is newly defined for the terminal device to request information exposure. That is, the first information is sent over the newly defined message or service.

In some embodiments, if the second core network device is a NEF entity, the network consent information of the terminal device is sent over an existing message or service between the NWDAF entity and the NEF entity, or a new message or service is added for the terminal device to request information exposure. For example, the network consent information of the terminal device is sent by Nudm_SDM_Notification.

In some embodiments, if the second core network device is a newly defined network function entity, a message or service is newly defined for the terminal device to request information exposure. That is, the network consent information of the terminal device is sent over the newly defined message or service.

In some embodiments of the present disclosure, the method 200 further includes:

If the network consent information of the terminal device is updated, the fifth core network device sends updated network consent information of the terminal device to the network device.

In some embodiments, the method 200 further includes:

The network device determines, based on the updated network consent information of the terminal device, whether the terminal device is allowed to request the target information.

For example, if it is determined based on the network consent information of the terminal device before the update that the terminal device is allowed to request the target information, but it is determined based on the network consent information of the terminal device after the update that the terminal device is not allowed to request the target information, the network device executes a process shown in FIG. 8 or FIG. 9 to cancel the request for the target information.

In summary, in the embodiments of the present disclosure, the network device determines, based on the network consent information of the terminal device, whether the terminal device is allowed to request the target information, and further determines whether to expose the target information to the terminal device. For example, if it is determined that the terminal device is allowed to request the target information, the target information is exposed to the terminal device. In this way, the terminal device assists in the behavior of the terminal device based on the exposed target information.

For example, if the target information is analytics result information, the terminal device assists in an AI operation of the terminal device based on the analytics result information. Specifically, for example, if the analytics result information is a QoS sustainability result, the terminal device acquires a change in QoS within a future time period based on the QoS sustainability result such that the terminal device can adjust a split point of an AI model in time. For example, if QoS is good within the future time period, the terminal device reduces a quantity of layers of the computed AI model and transmits more data to a server, to reduce the computing power and energy consumption of the terminal device. If QoS is poor within the future time period, the terminal device increases the number of layers of the computed AI model and transmits less data to the server.

For another example, in FL, if the network device exposes network load information to the terminal device, the terminal device determines, based on the network load information, when a network condition is good, to support a large amount of model data interaction in FL and determine an execution time of the AI operation.

FIG. 10 is a schematic diagram of a wireless communication method 300 according to some embodiments of the present disclosure. As shown in FIG. 10, the method 300 includes at least part of the following content.

In S301, a second core network device acquires first information. The first information is used for requesting target information by a terminal device.

In S302, the second core network device sends the first information to a first core network device.

In some embodiments, the second core network device is a NEF entity or a newly defined network function entity.

In some embodiments, the first information includes at least one of the following:
identification information of the terminal device, used for identifying the terminal device;
identification information of the target information, used for identifying the target information;
an application ID used for identifying an application requesting the target information on the terminal device;
an analytics ID corresponding to the target information;
target time information corresponding to the target information; or
target address information corresponding to the target information.

In some embodiments, the target information includes at least one of the following:
analytics information, access management information of the terminal device, or session information of the terminal device.

It should be understood that for specific implementation of the first information and the target information in the method 300, reference is made to the related implementation in the method 200. For brevity, details are not described herein again.

In some embodiments, the first information is acquired from a third core network device.

In some embodiments, the third core network device is an AF entity, such as a DCAF entity.

In some embodiments, if the second core network device is a NEF entity, the first information is sent over an existing message or service between the DCAF entity and the NEF entity, or a new message or service is added for the terminal device to request information exposure.

In some embodiments, the first information is sent by Nnef_AnalyticsSubscription_Subscribe.

In some embodiments, if the second core network device is a newly defined network function entity, a message or service is newly defined for the terminal device to request information exposure. That is, the first information is sent over the newly defined message or service.

In some embodiments of the present disclosure, the method 300 further includes:

The second core network device receives a first message from the first core network device. The first message indicates that the terminal device is not allowed to request the target information.

In some embodiments, the first core network device is an NWDAF entity.

In some embodiments, the first message further indicates at least one of the following:
the identification information of the terminal device, used for identifying the terminal device;
the identification information of the target information, used for identifying the target information;
the application ID used for identifying the application requesting the target information on the terminal device; or
the analytics ID corresponding to the target information.

In some embodiments of the present disclosure, the method 300 further includes:

The second core network device sends a sixth message to the third core network device. The sixth message indicates that the terminal device is not allowed to request the target information.

In some embodiments of the present disclosure, the sixth message further indicates at least one of the following:
the identification information of the terminal device, used for identifying the terminal device;
the identification information of the target information, used for identifying the target information;
the application ID used for identifying the application requesting the target information on the terminal device; or
the analytics ID corresponding to the target information.

In some embodiments of the present disclosure, the method 300 further includes:

The second core network device receives a seventh message from the third core network device. The seventh message is used for canceling the request for the target information.

In some embodiments of the present disclosure, the method 300 further includes:

The second core network device sends a second message to the first core network device. The second message indicates that the terminal device cancels the request for the target information.

It should be understood that the first message, the second message, the sixth message, and the seventh message correspond to those in the method 200. For their specific implementation, reference is made to the related description of the first message, the second message, the sixth message, and the seventh message in the method 200. For brevity, details are not described herein again.

In some embodiments of the present disclosure, the method 300 further includes:

The second core network device receives the target information from the first core network device.

The second core network device sends the target information to the third core network device.

For example, if the first core network device is a device providing the target information, the first core network device sends the target information to the second core network device. Further, the third core network device sends the target information to the terminal device.

In some embodiments of the present disclosure, the method 300 further includes:

The second core network device receives updated network consent information of the terminal device from the first core network device.

The second core network device sends the updated network consent information of the terminal device to the third core network device.

For example, if the network consent information of the terminal device changes, a fifth core network device sends the updated network consent information of the terminal device to the first core network device. Further, the first core network device sends the updated network consent information of the terminal device to the second core network device. Then, the second core network device sends the updated network consent information of the terminal device to the third core network device.

FIG. 11 is a schematic diagram of a wireless communication method 400 according to some embodiments of the present disclosure. As shown in FIG. 11, the method 400 includes at least part of the following content.

In S401, a third core network device acquires first information. The first information is used for requesting target information by a terminal device.

In S402, the third core network device sends the first information to a second core network device.

In some embodiments, the third core network device is an AF entity, such as a DCAF entity.

In some embodiments, the first information includes at least one of the following:
identification information of the terminal device, used for identifying the terminal device;
identification information of the target information, used for identifying the target information;
an application ID used for identifying an application requesting the target information on the terminal device;
an analytics ID corresponding to the target information;
target time information corresponding to the target information; or
target address information corresponding to the target information.

In some embodiments, the target information includes at least one of the following:
analytics information, access management information of the terminal device, or session information of the terminal device.

It should be understood that for a specific implementation of the first information and the target information in the method 400, reference is made to the related implementation in the method 200. For brevity, details are not described herein again.

In some embodiments, that the third core network device acquires the first information includes:
the third core network device acquires second information from the terminal device; and

The first information is determined based on the second information.

In some embodiments, the third core network device uses the second information as the first information, or converts application layer information in the second information into information that can be identified by a core network element.

For example, the target information is analytics information. The second information includes an application layer ID of the analytics information. The third core network device maps the application layer ID of the analytics information to a corresponding analytics ID.

In some embodiments, the second information includes at least one of the following:
application layer information corresponding to the target information;
the application ID of an application requesting the target information on the terminal device;
the target time information corresponding to the target information; or
the target address information corresponding to the target information.

In some embodiments, the application layer information corresponding to the target information includes an application layer ID of the target information.

In some embodiments, the analytics ID corresponding to the target information is acquired by mapping the application layer information corresponding to the target information. For example, the third core network device maps the application layer ID of the target information so as to acquire the analytics ID corresponding to the target information.

In some embodiments of the present disclosure, the method 400 further includes:

The third core network device receives a third message or a sixth message from the second core network device. The third message or the sixth message indicates that the terminal device is not allowed to request the target information.

The third core network device sends an eighth message to the terminal device. The eighth message indicates that the terminal device is not allowed to request the target information.

In some embodiments, the third message or the sixth message further indicates at least one of the following:
the identification information of the terminal device, used for identifying the terminal device;
the identification information of the target information, used for identifying the target information;
the application ID used for identifying the application requesting the target information on the terminal device; or
the analytics ID corresponding to the target information.

In some embodiments, the method 400 further includes:

The third core network device receives a ninth message from the terminal device. The ninth message indicates that the request for the target information is canceled.

The third core network device sends a fourth message or a seventh message to the second core network device. The fourth message or the seventh message indicates that the request for the target information is canceled.

It should be understood that for specific implementation of the third message, the fourth message, the sixth message, the seventh message, the eighth message, and the ninth message, reference is made to the related description in the method 200. For brevity, details are not described herein again.

In some embodiments of the present disclosure, the method 400 further includes:

The third core network device receives the target information from the second core network device.

The third core network device sends the target information to the terminal device.

In some embodiments, the second core network device is a NEF entity or a newly defined function entity.

In some embodiments of the present disclosure, the method 400 further includes:

The third core network device receives updated network consent information of the terminal device from the second core network device.

For example, if the network consent information of the terminal device changes, the fifth core network device sends the updated network consent information of the terminal device to the second core network device. Further, the second core network device sends the updated network consent information of the terminal device to the third core network device.

FIG. 12 is a schematic diagram of a wireless communication method 500 according to some embodiments of the present disclosure. As shown in FIG. 12, the method 500 includes at least part of the following content.

In S501, a terminal device sends second information to a third core network device. The second information is used for requesting target information.

In some embodiments, the second information includes at least one of the following:
application layer information corresponding to the target information;
an application ID used for identifying an application requesting the target information on the terminal device;
target time information corresponding to the target information; or
target address information corresponding to the target information.

In some embodiments, the target information includes at least one of the following:
analytics information, access management information of the terminal device, or session information of the terminal device.

In some embodiments of the present disclosure, the method 500 further includes:

The terminal device receives an eighth message from the third core network device. The eighth message indicates that the terminal device is not allowed to request the target information.

In some embodiments, the eighth message further indicates at least one of the following:
identification information of the terminal device, used for identifying the terminal device;
identification information of the target information, used for identifying the target information;
the application ID used for identifying the application requesting the target information on the terminal device; or
an analytics ID corresponding to the target information.

In some embodiments of the present disclosure, the method 500 further includes the following.

The terminal device sends a ninth message to the third core network device. The ninth message is used for canceling the request for the target information.

In some embodiments of the present disclosure, the method 500 further includes the following.

The terminal device receives the target information from the third core network device.

In some embodiments, the third core network device is an AF entity, such as a DCAF entity.

It should be understood that for specific implementation of the second information, the target information, the eighth message, and the ninth message in the method 500, reference is made to the related description in the foregoing embodiments. For brevity, details are not described herein again.

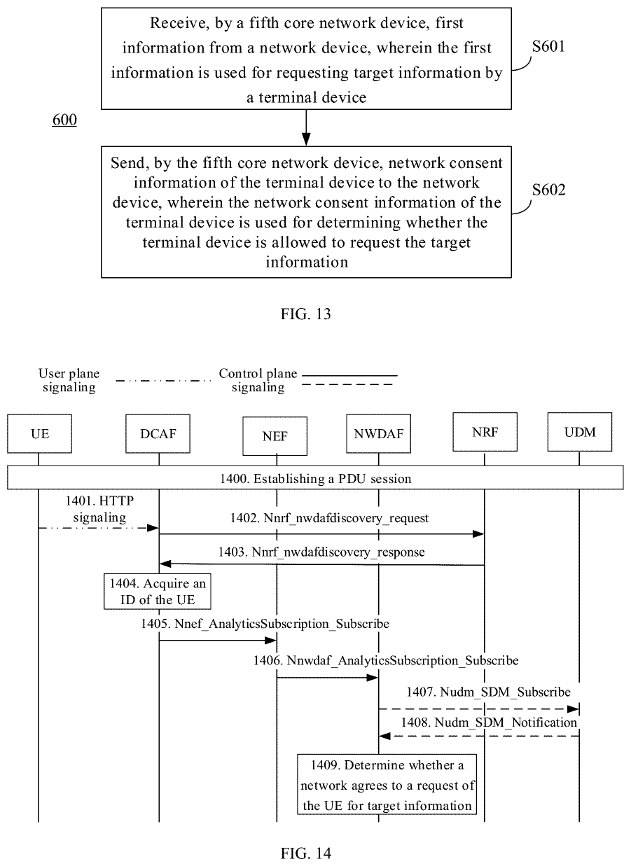

FIG. 13 is a schematic diagram of a wireless communication method 600 according to some embodiments of the present disclosure. As shown in FIG. 13, the method 600 includes at least part of the following content.

In S601, a fifth core network device receives first information from a network device. The first information is used for requesting target information by a terminal device.

In S602, the fifth core network device sends network consent information of the terminal device to the network device. The network consent information of the terminal device is used for determining whether the terminal device is allowed to request the target information.

In some embodiments, the first information includes at least one of the following:
identification information of the terminal device, used for identifying the terminal device;
identification information of the target information, used for identifying the target information;
an application ID used for identifying an application requesting the target information on the terminal device;
an analytics ID corresponding to the target information;
target time information corresponding to the target information; or
target address information corresponding to the target information.

In some embodiments, the target information includes at least one of the following:
analytics information, access management information of the terminal device, or session information of the terminal device.

In some embodiments, the network consent information of the terminal device includes at least one of the following:
information indicating whether the terminal device is allowed to request information, information allowed to be requested, information not allowed to be requested, an analytics ID corresponding to the information allowed to be requested, an analytics ID corresponding to the information not allowed to be requested, an application ID of the information allowed to be requested, an application ID of the information not allowed to be requested, time information of the information allowed to be requested, time information of the information not allowed to be requested, address information of the information allowed to be requested, or address information of the information not allowed to be requested.

In some embodiments, the method 600 further includes the following.

The fifth core network device sends updated network consent information of the terminal device to the network device.

In some embodiments, the fifth core network device is a UDM entity.

In some embodiments, the network device is an NWDAF entity, a NEF entity, or a newly defined function entity.

It should be understood that for specific implementations of the first information, the target information, and the network consent information of the terminal device in the method 500, references are made to the related description in the foregoing embodiments. For brevity, details are not described herein again.

With reference to FIG. 14 to FIG. 20, the following describes a specific process of the wireless communication method in the embodiments of the present disclosure from a perspective of device interaction by using an example in which a first core network device is an NWDAF entity, a second core network device is a NEF entity, a third core network device is a DCAF entity, a fourth core network device is an NF entity, and a fifth core network device is a UDM entity.

In FIG. 14 to FIG. 17, a network device verifying network consent information of a terminal device is the first core network device, and target information requested by the terminal device is analytics information. In FIG. 18 to FIG. 20, a network device verifying network consent information of a terminal device is the second core network device, and target information requested by the terminal device is analytics information, or other information, such as access management information or session information.

FIG. 14 is a schematic interaction diagram in which a first core network device verifies network consent information of a terminal device. As shown in FIG. 14, the method includes at least one of the following processes.

In process 1400, UE and a DCAF entity establish a protocol data unit (PDU) session.

In process 1401, the UE sends a subscription request to the DCAF entity. The subscription request includes the second information mentioned above.

For example, the second information includes analytics information to which the terminal device requests to subscribe, an ID of an application requesting to subscribe to the analytics information on the terminal device, and the like.

In some embodiments, the UE sends the subscription request to the DCAF entity over HTTP signaling.

In some embodiments, the DCAF entity determines first information based on the second information, for example, taking the second information as the first information or converting application layer information in the second information into information that can be identified by a core network element.

For example, the second information includes an application layer ID of the analytics information. The DCAF entity maps the application layer ID of the analytics information to a corresponding analytics ID.

Further, in processes 1402 and 1403, the DCAF entity discovers, by a network repository function (NRF) entity, an NWDAF entity that can provide the analytics ID.

For example, in process 1402, the DCAF entity sends Nnrf_nwdafdiscovery_request to the NRF entity, including the analytics ID corresponding to the analytics information requested by the terminal device. Optionally, Nnrf_nwdafdiscovery_request further includes a slice ID.

In process 1403, the NRF entity sends Nnrf_nwdafdiscovery_response to the DCAF entity, including an NWDAF ID of the NWDAF entity that can provide the analytics ID.

In process 1404, the DCAF entity acquires an ID of the UE.

For example, the DCAF entity acquires the ID of the UE, such as a SUPI or a GPSI, over an IP address of the UE.

In process 1405, the DCAF entity sends an analytics subscription request, such as Nnef_AnalyticsSubscription_Subscribe, to a NEF entity. The analytics subscription request includes the first information, for example, one or more of the UE ID, the application ID, and the analytics ID corresponding to the analytics information to which the UE wants to subscribe.

In some embodiments, the analytics subscription request further includes other parameter information of the analytics information, such as a target time period (indicating a time period corresponding to the analytics information, for example, in the past or the future) of the analytics information and a target address at which notification of the analytics information is given. The foregoing parameters are used by the NWDAF entity to determine whether a network agrees to the analytics subscription request.

In process 1406, the NEF entity sends the analytics subscription request to the NWDAF entity, including the information described in process 1405.

For example, the NEF entity sends the analytics subscription request by Nnwdaf_AnalyticsSubscription_Subscribe.

In processes 1407 and 1408, the NWDAF entity queries network consent information of the UE.

For example, when the NWDAF entity receives the analytics subscription request, a process of querying the network consent information of the UE is triggered to further determine whether the network agrees to the request of the UE for the analytics information.

For example, the NWDAF entity queries the network consent information of the UE from a UDM entity by Nudm_SD_MSubscribe. Nudm_SD_MSubscribe includes the UE ID, the application ID, and the analytics ID, and further includes other parameter information described in process 1405. The UDM entity provides the network consent information of the UE to the NWDAF entity by Nudm_SDM_Notification.

In process 1409, the NWDAF entity determines, based on the acquired network consent information of the UE, whether the network agrees to the request of the UE for the analytics information.

In some embodiments, if at least one of the following conditions is met, the NWDAF entity determines that the network does not agree to the request of the UE for the analytics information:
all analytics information requested by the UE ID is not allowed; the analytics ID requested by the UE is not allowed; the application ID corresponding to the application requesting the analytics information on the UE is not allowed; or another parameter requested by the UE is not allowed, for example, the target address at which notification of the analytics information is given is not allowed, or the requested target time period is not allowed.

In some embodiments, if at least one of the following conditions is met, the NWDAF entity determines that the network agrees to the request of the UE for the analytics information:
all analytics information requested by the UE ID is allowed; the analytics ID requested by the UE is allowed; the application ID corresponding to the application requesting the analytics information on the UE is allowed; or another parameter requested by the UE is allowed, for example, the target address at which notification of the analytics information is given is allowed, or the requested target time period is allowed.

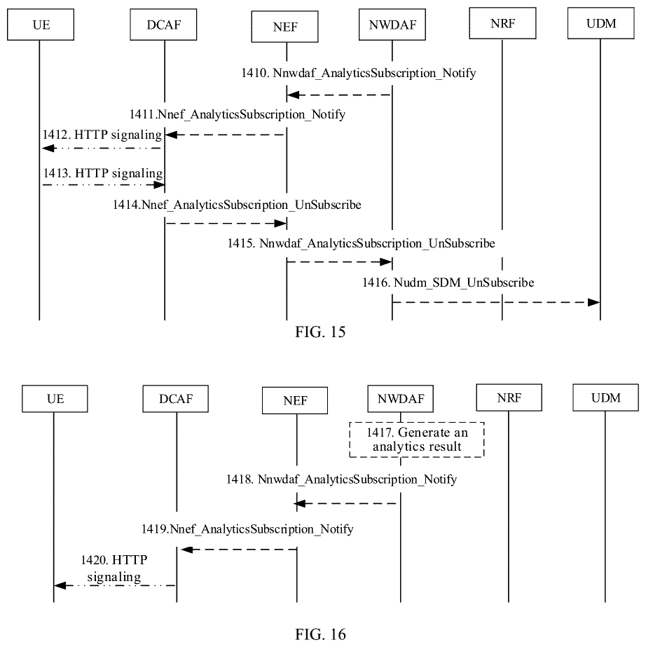

If it is determined that the network does not agree to the request of the UE for the analytics information, processes shown in FIG. 15 are performed to unsubscribe from the analytics information.

In process 1410, the NWDAF entity sends Nnwdaf_AnalyticsSubscription_Notify to the NEF entity, indicating that the UE is not allowed to request the analytics information.

Optionally, Nnwdaf_AnalyticsSubscription_Notify includes a network consent failure parameter indicating that the UE is not allowed to request the analytics information.

In some embodiments, Nnwdaf_AnalyticsSubscription_Notify further includes the UE ID, the application ID, and the like.

In process 1411, the NEF entity sends the network consent failure parameter to the DCAF entity, indicating that the UE is not allowed to request the analytics information.

For example, the NEF entity sends Nnef_AnalyticsSubscription_Notify to the DCAF entity, including the network consent failure parameter.

In some embodiments, Nnef_AnalyticsSubscription_Notify further includes the UE ID, the application ID, and the like.

In process 1412, the DCAF entity sends the network consent failure parameter to the UE, indicating that the UE is not allowed to request the analytics information.

For example, the DCAF entity sends HTTP signaling to the UE, including the network consent failure parameter.

In some embodiments, the HTTP signaling further includes the UE ID, a response to the request, and the like.

In process 1413, after receiving the network consent failure parameter, the UE sends an unsubscription request to the DCAF entity, indicating unsubscription from the analytics information.

For example, the UE sends the unsubscription request to the DCAF entity over HTTP signaling.

In process 1414, the DCAF entity sends the unsubscription request to the NEF entity.

For example, the DCAF entity sends Nnef_AnalyticsSubscription_UnSubscribe to the NEF entity, indicating unsubscription from the analytics information.

In process 1415, the NEF entity sends the unsubscription request to the NWDAF entity.

For example, the NEF entity sends Nnwdaf_AnalyticsSubscription_UnSubscribe to the NWDAF entity, indicating unsubscription from the analytics information.

In process 1416, the NWDAF entity sends the unsubscription request to the UDM entity.

For example, the NWDAF entity sends Nudm_SDM_UnSubscribe to the UDM entity.

If it is determined that the network agrees to the request of the UE for the analytics information, processes shown in FIG. 16 are performed to acquire the analytics information.

In process 1417, the NWDAF entity generates the analytics information. For example, if it is determined that the network agrees to the request of the UE for the analytics information, the NWDAF entity executes an analytics process to generate the analytics information.

In processes 1418 to 1420, the network sends the analytics information to the UE.

In process 1418, the NWDAF entity sends the analytics information to the NEF entity.

For example, the analytics information is sent to the NEF entity by Nnwdaf_AnalyticsSubscription_Notify.

In process 1419, the NEF entity sends the analytics information to the DCAF entity.

For example, the analytics information is sent to the DCAF entity by Nnef_AnalyticsSubscription_Notify.

In process 1420, the DCAF entity sends the analytics information to the UE.

For example, the analytics information is sent to the UE over HTTP signaling.

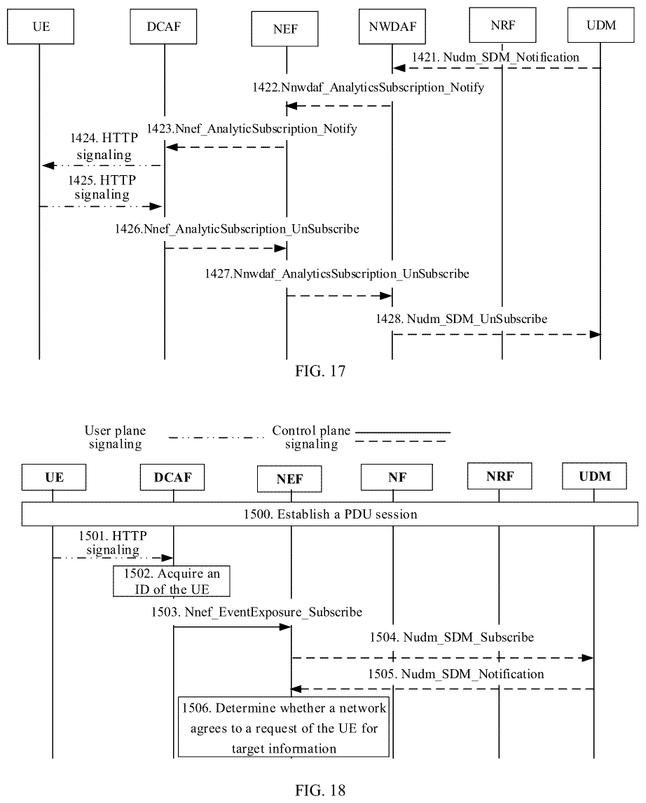

If the network consent information of the UE changes, a process shown in FIG. 17 is executed to update the network consent information of the UE.

In process 1421, the UDM entity sends updated network consent information of the UE to the NWDAF entity by Nudm_SDM_Notification.

In processes 1422 to 1428, the NWDAF entity determines, based on the updated network consent information of the UE, whether the network agrees to the request of the UE for the analytics information. Further, a corresponding determining result is sent to the NEF entity and the DCAF entity.

For example, if it is determined based on the network consent information of the UE before the update that the UE is allowed to request the analytics information, but it is determined based on the network consent information of the UE after the update that the UE is not allowed to request the analytics information, processes 1425 to 1428 in FIG. 17 are performed to unsubscribe from the analytics information.

FIG. 18 is a schematic interaction diagram in which a second core network device verifies network consent information of a terminal device. As shown in FIG. 18, the method includes at least one of the following processes.

In process 1500, UE and a DCAF entity establish a PDU session.

In process 1501, the UE sends a subscription request to the DCAF entity. The subscription request includes the second information mentioned above.

For example, the second information includes information to which the terminal device requests to subscribe, an ID of an application requesting to subscribe to the information on the terminal device, and the like.

In some embodiments, the UE sends the subscription request to the DCAF entity over HTTP signaling.

In some embodiments, the DCAF entity determines first information based on the second information, for example, taking the second information as the first information or converting application layer information in the second information into information that can be identified by a core network element.

In process 1502, the DCAF entity acquires an ID of the UE.

For example, the DCAF entity acquires the ID of the UE, such as a SUPI or a GPSI, over an IP address of the UE.

In process 1503, the DCAF entity sends an information exposure and subscription request, such as Nnef_EventExposure_Subscribe, to a NEF entity. The information exposure and subscription request include the first information, for example, one or more of the UE ID, the application ID, and target information to which the UE wants to subscribe.

In processes 1504 and 1505, the NEF entity queries network consent information of the UE.

For example, when the NEF entity receives the information exposure and subscription request, a process of querying the network consent information of the UE is triggered to further determine whether the network agrees to the request of the UE for the target information.

For example, the NEF entity queries the network consent information of the UE from a UDM entity by Nudm_SD_MSubscribe. Nudm_SD_MSubscribe includes the UE ID, the application ID, and the target information requested by the UE. The UDM entity provides the network consent information of the UE to the NEF entity by Nudm_SDM_Notification.

In process 1506, the NEF entity determines, based on the acquired network consent information of the UE, whether the network agrees to the request of the UE for the target information.

In some embodiments, if at least one of the following conditions is met, the NEF entity determines that the network does not agree to the request of the UE for the target information:
all information requested by the UE ID is not allowed; the application ID corresponding to the application requesting the target information on the UE is not allowed; or another parameter requested by the UE is not allowed, for example, a target address at which notification of the target information is given is not allowed, or a requested target time period is not allowed.

In some embodiments, if at least one of the following conditions is met, the NEF entity determines that the network agrees to the request of the UE for the target information:
all information requested by the UE ID is allowed; the application ID corresponding to the application requesting the target information on the UE is allowed; or another parameter requested by the UE is allowed, for example, a target address at which notification of the target information is given is allowed, or a requested target time period is allowed.

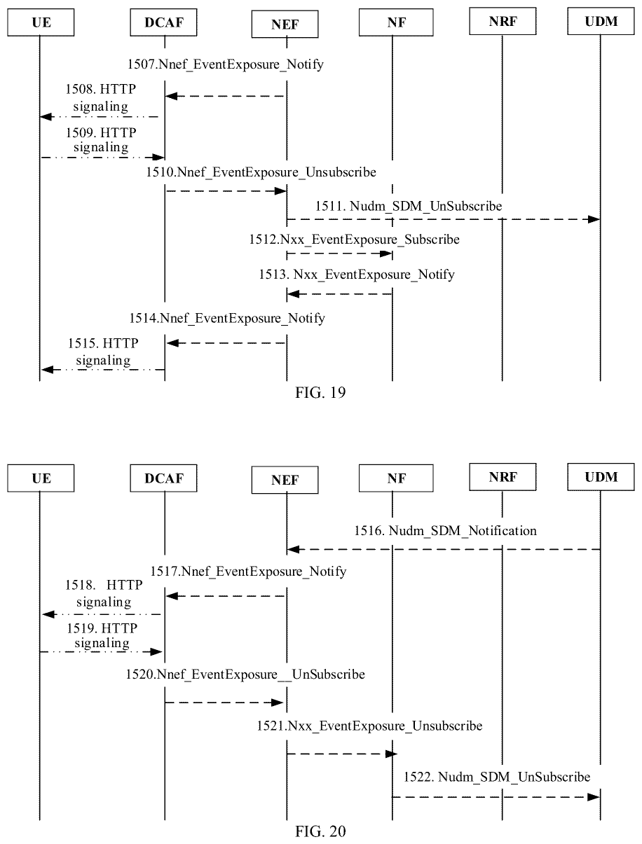

If it is determined that the network does not agree to the request of the UE for the target information, processes shown in FIG. 19 are performed to cancel the request to expose the target information.

In process 1507, the NEF entity sends Nnef_EventExposure_Notify to the DCAF entity, indicating that the UE is not allowed to request the target information.

Optionally, Nnef_EventExposure_Notify includes a network consent failure parameter indicating that the UE is not allowed to request the target information.

In some embodiments, Nnef_EventExposure_Notify further includes the UE ID, the application ID, and the like.

In process 1508, the DCAF entity sends the network consent failure parameter to the UE, indicating that the UE is not allowed to request the target information.

For example, the DCAF entity sends HTTP signaling to the UE, including the network consent failure parameter.

In some embodiments, the HTTP signaling further includes the UE ID, a response to the request, and the like.

In process 1509, after receiving the network consent failure parameter, the UE sends an unsubscription request to the DCAF entity, used for canceling the request to expose the target information.

For example, the UE sends the unsubscription request to the DCAF entity over HTTP signaling.

In process 1510, the DCAF entity sends the unsubscription request to the NEF entity.

For example, the DCAF entity sends Nnef_EventExposure_Unsubscribe to the NEF entity, used for canceling the request to expose the target information.

In process 1511, the NEF entity sends the unsubscription request to the UDM entity.

For example, the NEF entity sends Nudm_SDM_UnSubscribe to the UDM entity.

If it is determined that the network agrees to the request of the UE for the target information, processes 1512 to 1515 in FIG. 19 are performed.

In processes 1512 and 1513, the NEF entity acquires the target information from an NF entity.

For example, in process 1512, the NEF entity sends a subscription request to the NF entity.

Optionally, the target information is analytics information, and the NF entity is an NWDAF entity.

Optionally, the target information is access management information, and the NF entity is an AMF entity.

Optionally, the target information is session information, and the NF entity is an SMF entity.

As an example, the subscription request is Nxx_EventExposure_Subscribe. Nxx_EventExposure_Subscribe subscribes to events or information between the NEF entity and the NF entity. xx represents a name of the NF entity.

For example, in process 1513, the NF entity sends the target information to the NEF entity.

As an example, the NF entity sends the target information by Nxx_EventExposure_Notify. Nxx_EventExposure_Subscribe exposes the events or information between the NEF entity and the NF entity.

In process 1514, the NEF entity sends the target information to the DCAF entity.

For example, the NEF entity sends the target information to the DCAF entity over Nnef_EventExposure_Notify.

In process 1515, the DCAF entity sends the target information to the UE.

For example, the DCAF entity sends the target information over HTTP signaling.

If the network consent information of the UE changes, a process shown in FIG. 20 is executed to update the network consent information of the UE.

In process 1516, the UDM entity sends updated network consent information of the UE to the NEF entity over Nudm_SDM_Notification.

In processes 1517 and 1518, the NEF entity determines, based on the updated network consent information of the UE, whether the network agrees to the request of the UE for the target information. Further, a corresponding determining result is sent to the DCAF entity.

For example, if it is determined based on the network consent information of the UE before the update that the UE is allowed to request the target information, but it is determined based on the network consent information of the UE after the update that the UE is not allowed to request the target information, processes 1519 to 1522 in FIG. 20 are performed to unsubscribe from the target information.

In summary, in the embodiments of the present disclosure, the NWDAF entity or the NEF entity determines, based on the network consent information of the terminal device, whether the terminal device is allowed to request the target information, and further determine whether to expose the target information to the terminal device. For example, if it is determined that the terminal device is allowed to request the target information, the target information is exposed to the terminal device. In this way, the terminal device assists in the behavior of the terminal device based on the exposed target information.

For example, if the target information is analytics result information, the terminal device assists in an AI operation of the terminal device based on the analytics result information. Specifically, for example, if the analytics result information is a QoS sustainability result, the terminal device acquires a change in QoS within a future time period based on the QoS sustainability result such that the terminal device adjusts a split point of an AI model in time. For example, if QoS is good within the future time period, the terminal device reduces a quantity of layers of the computed AI model and transmits more data to a server, to reduce computing power and energy consumption of the terminal device. If QoS is poor within the future time period, the terminal device increases the quantity of layers of the computed AI model and transmits less data to the server.

For another example, in FL, if the network device exposes network load information to the terminal device, the terminal device can determine, based on the network load information, when a network condition is good, to support a large amount of model data interaction in FL and determine an execution time of the AI operation.

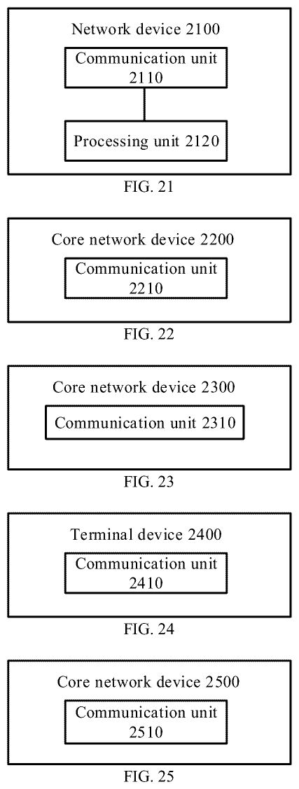

The method embodiments of the present disclosure are described in detail above with reference to FIG. 7 to FIG. 20. The apparatus embodiments of the present disclosure are described in detail below with reference to FIG. 21 to 29. It should be understood that the apparatus embodiments correspond to the method embodiments. For similar descriptions, reference is made to the method embodiments.

FIG. 21 is a schematic block diagram of a network device 2100 according to some embodiments of the present disclosure. As shown in FIG. 21, the network device 2100 includes:
a communication unit 2110 configured to acquire first information, wherein the first information is used for requesting target information by a terminal device; and
acquire network consent information of the terminal device based on the first information; and
a processing unit 2120 configured to determine, based on the network consent information of the terminal device, whether the terminal device is allowed to request the target information.

In some embodiments, the first information includes at least one of the following:
identification information of the terminal device, used for identifying the terminal device;
identification information of the target information, used for identifying the target information;
an application ID used for identifying an application requesting the target information on the terminal device;
an analytics ID corresponding to the target information;
target time information corresponding to the target information; or
target address information corresponding to the target information.

In some embodiments, the target information includes at least one of the following:
analytics information, access management information of the terminal device, or session information of the terminal device.

In some embodiments, a granularity of the network consent information of the terminal device includes at least one of the following:
per terminal device, per analytics ID, or per application ID.

In some embodiments, the network consent information of the terminal device includes at least one of the following:
information indicating whether the terminal device is allowed to request information, information allowed to be requested, information not allowed to be requested, an analytics ID corresponding to the information allowed to be requested, an analytics ID corresponding to the information not allowed to be requested, an application ID of the information allowed to be requested, an application ID of the information not allowed to be requested, time information of the information allowed to be requested, time information of the information not allowed to be requested, address information of the information allowed to be requested, or address information of the information not allowed to be requested.

In some embodiments, the network device is a first core network device.

In some embodiments, the communication unit 2110 is further configured to:
send a first message to a second core network device in response to determining that the terminal device is not allowed to request the target information, wherein the first message indicates that the terminal device is not allowed to request the target information.

In some embodiments, the first message further indicates at least one of the following:
the identification information of the terminal device, used for identifying the terminal device;
the identification information of the target information, used for identifying the target information;
the application ID used for identifying the application requesting the target information on the terminal device; or
the analytics ID corresponding to the target information.

In some embodiments, the communication unit 2110 is further configured to:
receive a second message from the second core network device, wherein the second message indicates that the terminal device cancels the request for the target information.

In some embodiments, the communication unit 2110 is further configured to send the target information to a second core network device in response to determining that the terminal device is allowed to request the target information and the target information is provided by the network device.

In some embodiments, the first information is acquired from the second core network device.

In some embodiments, the first core network device is an NWDAF entity, and the second core network device is a NEF entity or a newly defined function entity.

In some embodiments, the network device is a second core network device.

In some embodiments, the first information is acquired from a third core network device.

In some embodiments, the communication unit 2110 is further configured to:
send a third message to the third core network device in a case of determining that the terminal device is not allowed to request the target information, wherein the third message indicates that the terminal device is not allowed to request the target information.

In some embodiments, the third message further indicates at least one of the following:
the identification information of the terminal device, used for identifying the terminal device;
the identification information of the target information, used for identifying the target information;
the application ID used for identifying the application requesting the target information on the terminal device; or
the analytics ID corresponding to the target information.

In some embodiments, the communication unit 2110 is further configured to receive a fourth message from the third core network device. The fourth message indicates that the terminal device cancels the request for the target information.

In some embodiments, the communication unit 2110 is further configured to:
send a fifth message to a fourth core network device in response to determining that the terminal device is allowed to request the target information, wherein the fifth message is used for requesting the fourth core network device to provide the target information; and
receive the target information from the fourth core network device.

In some embodiments, the communication unit 2110 is further configured to send the target information to the third core network device.

In some embodiments, the fourth core network device is an NF entity.

In some embodiments, the second core network device is a NEF entity or a newly defined function entity, and the third core network device is an AF entity.

In some embodiments, the network consent information of the terminal device is acquired from a fifth core network device.

In some embodiments, the communication unit 2110 is further configured to:
send the first information to the fifth core network device; and
receive the network consent information of the terminal device from the fifth core network device.

In some embodiments, the communication unit 2110 is further configured to:
receive updated network consent information of the terminal device from the fifth core network device.

In some embodiments, the processing unit 2120 is further configured to:
determine, based on the updated network consent information of the terminal device, whether the terminal device is allowed to request the target information.

In some embodiments, the fifth core network device is a UDM entity.

Optionally, in some embodiments, the communication unit is a communication interface, a transceiver, or an input/output interface of a communication chip or a system on a chip. The processing unit is one or more processors.

It should be understood that the network device 2100 in the embodiments of the present disclosure corresponds to the network device in the method embodiments of the present disclosure. In addition, the foregoing and other operations and/or functions of each unit in the network device 2100 are configured to implement corresponding processes of the network device (for example, the first core network device or the second core network device) in the methods shown in FIG. 7 to 20. For brevity, details are not described herein again.

FIG. 22 is a schematic block diagram of a core network device according to some embodiments of the present disclosure. A core network device 2200 in FIG. 22 includes:
a communication unit 2210 configured to acquire first information, wherein the first information is used for requesting target information by a terminal device; and
send the first information to a first core network device.

In some embodiments, the first information includes at least one of the following:
identification information of the terminal device, used for identifying the terminal device;
identification information of the target information, used for identifying the target information;
an application ID used for identifying an application requesting the target information on the terminal device;
an analytics ID corresponding to the target information;
target time information corresponding to the target information; or
target address information corresponding to the target information.

In some embodiments, the target information includes at least one of the following:
analytics information, access management information of the terminal device, or session information of the terminal device.

In some embodiments, the first information is acquired from a third core network device.

In some embodiments, the communication unit 2210 is further configured to receive a first message from the first core network device. The first message indicates that the terminal device is not allowed to request the target information.

In some embodiments, the first message further indicates at least one of the following:
the identification information of the terminal device, used for identifying the terminal device;
the identification information of the target information, used for identifying the target information;
the application ID used for identifying the application requesting the target information on the terminal device; or
the analytics ID corresponding to the target information.

In some embodiments, the communication unit 2210 is further configured to send a sixth message to the third core network device. The sixth message indicates that the terminal device is not allowed to request the target information.

In some embodiments, the sixth message further indicates at least one of the following:
the identification information of the terminal device, used for identifying the terminal device;
the identification information of the target information, used for identifying the target information;
the application ID used for identifying the application requesting the target information on the terminal device; or
the analytics ID corresponding to the target information.

In some embodiments, the communication unit 2210 is further configured to:
receive a seventh message from the third core network device, wherein the seventh message is used for canceling the request for the target information.

In some embodiments, the communication unit 2210 is further configured to send a second message to the first core network device. The second message indicates that the terminal device cancels the request for the target information.

In some embodiments, the communication unit 2210 is further configured to:
receive the target information from the first core network device; and
send the target information to the third core network device.

In some embodiments, the communication unit 2210 is further configured to:
receive updated network consent information of the terminal device from the first core network device.

In some embodiments, the communication unit 2210 is further configured to:
send the updated network consent information of the terminal device to the third core network device.

In some embodiments, the third core network device is an AF entity.

In some embodiments, the first core network device is an NWDAF entity, and the second core network device is a NEF entity or a newly defined function entity.

Optionally, in some embodiments, the communication unit is a communication interface, a transceiver, or an input/output interface of a communication chip or a system on a chip. The processing unit is one or more processors.

It should be understood that the core network device 2200 in the embodiments of the present disclosure corresponds to the second core network device in the method embodiments of the present disclosure. In addition, the foregoing and other operations and/or functions of each unit in the core network device 2200 are configured to implement corresponding processes of the second core network device in the methods shown in FIG. 7 to FIG. 20. For brevity, details are not described herein again.

FIG. 23 is a schematic block diagram of a core network device according to some embodiments of the present disclosure. A core network device 2300 in FIG. 23 includes:
a communication unit 2310 configured to acquire first information, wherein the first information is used for requesting target information by a terminal device; and
send the first information to a second core network device.

In some embodiments, the first information includes at least one of the following:
identification information of the terminal device, used for identifying the terminal device;
identification information of the target information, used for identifying the target information;
an application ID used for identifying an application requesting the target information on the terminal device;
an analytics ID corresponding to the target information;
target time information corresponding to the target information; or
target address information corresponding to the target information.

In some embodiments, the target information includes at least one of the following:
analytics information, access management information of the terminal device, or session information of the terminal device.

In some embodiments, the communication unit 2310 is further configured to acquire second information from the terminal device. The first information is determined based on the second information.

In some embodiments, the second information includes at least one of the following:
application layer information corresponding to the target information;
the application ID of the application requesting the target information on the terminal device;
the target time information corresponding to the target information; or
the target address information corresponding to the target information.

In some embodiments, the analytics ID corresponding to the target information is acquired by mapping the application layer information corresponding to the target information.

In some embodiments, the communication unit 2310 is further configured to:
receive a third message or a sixth message from the second core network device, wherein the third message or the sixth message indicates that the terminal device is not allowed to request the target information; and
send an eighth message to the terminal device, wherein the eighth message indicates that the terminal device is not allowed to request the target information.

In some embodiments, the third message or the sixth message further indicates at least one of the following:
the identification information of the terminal device, used for identifying the terminal device;
the identification information of the target information, used for identifying the target information;
the application ID used for identifying the application requesting the target information on the terminal device; or
the analytics ID corresponding to the target information.

In some embodiments, the communication unit 2310 is further configured to:
receive a ninth message from the terminal device, wherein the ninth message indicates that the request for the target information is canceled; and
send a fourth message or a seventh message to the second core network device, wherein the fourth message or the seventh message indicates that the request for the target information is canceled.

In some embodiments, the communication unit 2310 is further configured to:
receive the target information from the second core network device; and
send the target information to the terminal device.

In some embodiments, the third core network device is an AF entity, and the second core network device is a NEF entity or a newly defined function entity.

Optionally, in some embodiments, the communication unit is a communication interface, a transceiver, or an input/output interface of a communication chip or a system on a chip. The processing unit is one or more processors.

It should be understood that the core network device 2300 in the embodiments of the present disclosure corresponds to the third core network device in the method embodiments of the present disclosure. In addition, the foregoing and other operations and/or functions of each unit in the core network device 2300 are configured to implement corresponding processes of the third core network device in the methods shown in FIG. 7 to FIG. 20. For brevity, details are not described herein again.

FIG. 24 is a schematic block diagram of a terminal device 2400 according to some embodiments of the present disclosure. As shown in FIG. 24, the terminal device 2400 includes:
a communication unit 2410 configured to send second information to a third core network device, wherein the second information is used for requesting target information.

In some embodiments, the second information includes at least one of the following:
application layer information corresponding to the target information;
an application ID used for identifying an application requesting the target information on the terminal device;
target time information corresponding to the target information; or
target address information corresponding to the target information.

In some embodiments, the target information includes at least one of the following:
analytics information, access management information of the terminal device, or session information of the terminal device.

In some embodiments, the communication unit 2410 is further configured to receive an eighth message from the third core network device. The eighth message indicates that the terminal device is not allowed to request the target information.

In some embodiments, the eighth message further indicates at least one of the following:
identification information of the terminal device, used for identifying the terminal device;
identification information of the target information, used for identifying the target information;
the application ID used for identifying the application requesting the target information on the terminal device; or
an analytics ID corresponding to the target information.

In some embodiments, the communication unit 2410 is further configured to:
send a ninth message to the third core network device, wherein the ninth message is used for canceling the request for the target information.

In some embodiments, the communication unit 2410 is further configured to receive the target information from the third core network device.

In some embodiments, the third core network device is an AF entity.

Optionally, in some embodiments, the communication unit is a communication interface, a transceiver, or an input/output interface of a communication chip or a system on a chip. The processing unit is one or more processors.

It should be understood that the terminal device 2400 in the embodiments of the present disclosure corresponds to the terminal device in the method embodiments of the present disclosure.

In addition, the foregoing and other operations and/or functions of each unit in the terminal device 2400 are configured to implement corresponding processes of the terminal device in the methods shown in FIG. 7 to FIG. 20. For brevity, details are not described herein again.

FIG. 25 is a schematic block diagram of a core network device according to some embodiments of the present disclosure. A core network device 2500 in FIG. 25 includes:
a communication unit 2510 configured to receive first information from a network device, wherein the first information is used for requesting target information by a terminal device; and send network consent information of the terminal device to the network device, wherein the network consent information of the terminal device is used for determining whether the terminal device is allowed to request the target information.

In some embodiments, the first information includes at least one of the following:
identification information of the terminal device, used for identifying the terminal device;
identification information of the target information, used for identifying the target information;
an application ID used for identifying an application requesting the target information on the terminal device;
an analytics ID corresponding to the target information;
target time information corresponding to the target information; or
target address information corresponding to the target information.

In some embodiments, the target information includes at least one of the following:
analytics information, access management information of the terminal device, or session information of the terminal device.

In some embodiments, a granularity of the network consent information of the terminal device includes at least one of the following:
per terminal device, per analytics ID, or per application ID.

In some embodiments, the network consent information of the terminal device includes at least one of the following:
information indicating whether the terminal device is allowed to request information, information allowed to be requested, information not allowed to be requested, an analytics ID corresponding to the information allowed to be requested, an analytics ID corresponding to the information not allowed to be requested, an application ID of the information allowed to be requested, an application ID of the information not allowed to be requested, time information of the information allowed to be requested, time information of the information not allowed to be requested, address information of the information allowed to be requested, or address information of the information not allowed to be requested.

In some embodiments, the communication unit 2510 is further configured to:
send updated network consent information of the terminal device to the network device.

In some embodiments, the fifth core network device is a UDM entity.

In some embodiments, the network device is an NWDAF entity, a NEF entity, or a newly defined function entity.

Optionally, in some embodiments, the communication unit is a communication interface, a transceiver, or an input/output interface of a communication chip or a system on a chip. The processing unit is one or more processors.

It should be understood that the core network device 2500 in the embodiments of the present disclosure corresponds to the fifth core network device in the method embodiments of the present disclosure. In addition, the foregoing and other operations and/or functions of each unit in the core network device 2500 are configured to implement corresponding processes of the fifth core network device in the methods shown in FIG. 7 to FIG. 20. For brevity, details are not described herein again.

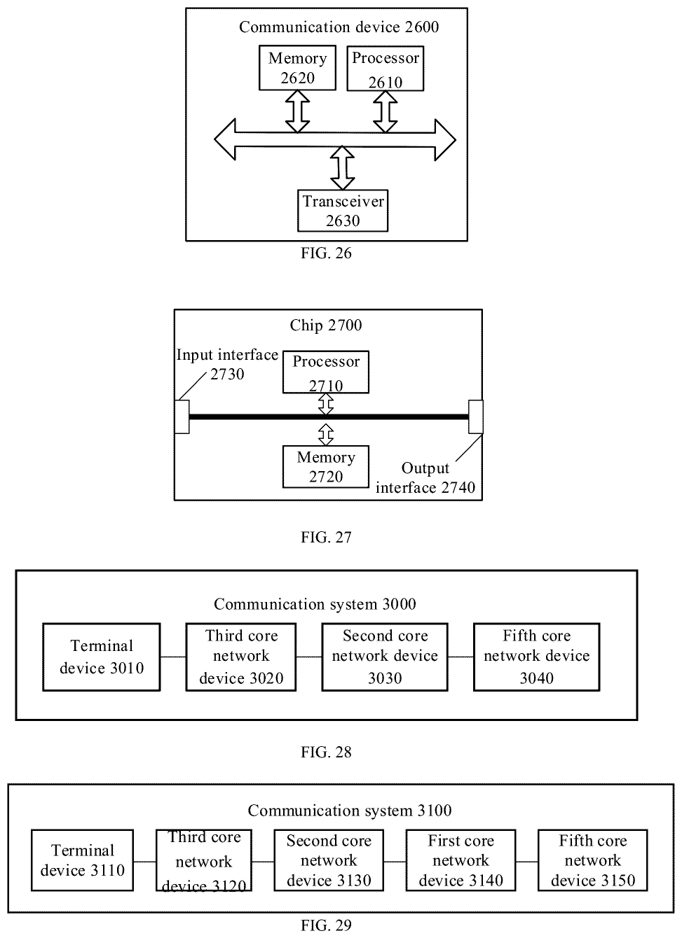

FIG. 26 is a schematic structural diagram of a communication device 2600 according to some embodiments of the present disclosure. The communication device 2600 shown in FIG. 26 includes a processor 2610. The processor 2610 calls and runs one or more computer programs in a memory to implement the methods in the embodiments of the present disclosure.

Optionally, as shown in FIG. 26, the communication device 2600 further includes a memory 2620. The processor 2610 calls and runs one or more computer programs in the memory 2620 to implement the methods in the embodiments of the present disclosure.

The memory 2620 is a component independent from the processor 2610 or is integrated in the processor 2610.

Optionally, as shown in FIG. 26, the communication device 2600 further includes a transceiver 2630. The processor 2610 controls the transceiver 2630 to communicate with other devices, specifically, to send information or data to other devices or receive information or data from other devices.

The transceiver 2630 includes a transmitter and a receiver. The transceiver 2630 further includes one or more antennas.

Optionally, the communication device 2600 is specifically the network device in the embodiments of the present disclosure. The communication device 2600 implements a corresponding process implemented by the network device in each method in the embodiments of the present disclosure. For brevity, details are not described herein again.

Optionally, the communication device 2600 is specifically the first core network device in the embodiments of the present disclosure. The communication device 2600 implements a corresponding process implemented by the first core network device in each method in the embodiments of the present disclosure. For brevity, details are not described herein again.

Optionally, the communication device 2600 is specifically the second core network device in the embodiments of the present disclosure. The communication device 2600 implements a corresponding process implemented by the second core network device in each method in the embodiments of the present disclosure. For brevity, details are not described herein again.

Optionally, the communication device 2600 is specifically the third core network device in the embodiments of the present disclosure. The communication device 2600 implements a corresponding process implemented by the third core network device in each method in the embodiments of the present disclosure. For brevity, details are not described herein again.

Optionally, the communication device 2600 is specifically the fifth core network device in the embodiments of the present disclosure. The communication device 2600 implements a corresponding process implemented by the fifth core network device in each method in the embodiments of the present disclosure. For brevity, details are not described herein again.

Optionally, the communication device 2600 is specifically the terminal device in the embodiments of the present disclosure. The communication device 2600 implements a corresponding process implemented by the terminal device in each method in the embodiments of the present disclosure. For brevity, details are not described herein again.

FIG. 27 is a schematic structural diagram of a chip according to some embodiments of the present disclosure. A chip 2700 shown in FIG. 27 includes a processor 2710. The processor 2710 calls and runs one or more computer programs in a memory to implement the methods in the embodiments of the present disclosure.

Optionally, as shown in FIG. 27, the chip 2700 further includes a memory 2720. The processor 2710 calls and runs one or more computer programs in the memory 2720 to implement the methods in the embodiments of the present disclosure.

The memory 2720 is a component independent from the processor 2710 or is integrated in the processor 2710.

Optionally, the chip 2700 further includes an input interface 2730. The processor 2710 controls the input interface 2730 to communicate with other devices or chips, specifically, to acquire information or data from other devices or chips.

Optionally, the chip 2700 further includes an output interface 2740. The processor 2710 controls the output interface 2740 to communicate with other devices or chips, specifically, to output information or data to other devices or chips.

Optionally, the chip is applied to the network device in the embodiments of the present disclosure. The chip implements a corresponding process implemented by the network device in each method in the embodiments of the present disclosure. For brevity, details are not described herein again.

Optionally, the chip is applied to the first core network device in the embodiments of the present disclosure. The chip implements a corresponding process implemented by the first core network device in each method in the embodiments of the present disclosure. For brevity, details are not described herein again.

Optionally, the chip is applied to the second core network device in the embodiments of the present disclosure. The chip implements a corresponding process implemented by the second core network device in each method in the embodiments of the present disclosure. For brevity, details are not described herein again.

Optionally, the chip is applied to the third core network device in the embodiments of the present disclosure. The chip implements a corresponding process implemented by the third core network device in each method in the embodiments of the present disclosure. For brevity, details are not described herein again.

Optionally, the chip is applied to the fifth core network device in the embodiments of the present disclosure. The chip implements a corresponding process implemented by the fifth core network device in each method in the embodiments of the present disclosure. For brevity, details are not described herein again.

Optionally, the chip is applied to the terminal device in the embodiments of the present disclosure. The chip implements a corresponding process implemented by the terminal device in each method in the embodiments of the present disclosure. For brevity, details are not described herein again.

It should be understood that the chip in the embodiments of the present disclosure is also referred to as a system-level chip, a system chip, a chip system, a system on a chip, or the like.

FIG. 28 is a schematic block diagram of a communication system 3000 according to some embodiments of the present disclosure. As shown in FIG. 28, the communication system 3000 includes a terminal device 3010, a third core network device 3020, a second core network device 3030, and a fifth core network device 3040.

The terminal device 3010 is configured to implement corresponding functions implemented by the terminal device in the foregoing methods. The third core network device 3020 is configured to implement corresponding functions implemented by the third core network device in the foregoing methods. The second core network device 3030 is configured to implement corresponding functions implemented by the second core network device in the foregoing methods. The fifth core network device 3040 is configured to implement corresponding functions implemented by the fifth core network device in the foregoing methods. For brevity, details are not described herein again.

FIG. 29 is a schematic block diagram of a communication system 3100 according to some embodiments of the present disclosure. As shown in FIG. 29, the communication system 3100 includes a terminal device 3110, a third core network device 3120, a second core network device 3130, a first core network device 3140, and a fifth core network device 3150.

The terminal device 3110 is configured to implement corresponding functions implemented by the terminal device in the foregoing methods. The third core network device 3120 is configured to implement corresponding functions implemented by the third core network device in the foregoing methods. The second core network device 3130 is configured to implement corresponding functions implemented by the second core network device in the foregoing methods. The first core network device 3140 is configured to implement corresponding functions implemented by the first core network device in the foregoing methods. The fifth core network device 3150 is configured to implement corresponding functions implemented by the fifth core network device in the foregoing methods. For brevity, details are not described herein again.

It should be understood that the processor in the embodiments of the present disclosure is an integrated circuit chip capable of signal processing. During the implementation, each process in the foregoing method embodiments is performed by an integrated logic circuit of hardware in the processor or by using an instruction in a form of software. The processor is a general-purpose processor, a digital signal processor (DSP), an application-specific integrated circuit (ASIC), a field programmable gate array (FPGA) or another programmable logic device, a discrete gate or transistor logic device, or a discrete hardware component. The processor implements or executes the methods, processes, and logical block diagrams disclosed in the embodiments of the present disclosure. The general-purpose processor is a microprocessor, or the processor is any conventional processor or the like. The processes of the methods disclosed with reference to the embodiments of the present disclosure are directly performed by a hardware decoding processor, or performed by a combination of hardware and software modules in the decoding processor. The software module is located in a mature storage medium in the art, such as a random access memory (RAM), a flash memory, a read-only memory (ROM), a programmable ROM (PROM), an electrically erasable programmable memory, or a register. The storage medium is located in a memory. The processor reads information in the memory, and completes the processes of the foregoing methods in combination with hardware in the processor.

It can be understood that the memory in the embodiments of the present disclosure is a transitory memory or a non-transitory memory, or includes both a transitory memory and a non-transitory memory. The non-transitory memory is a ROM, a PROM, an erasable PROM (EPROM), an electrically EPROM (EEPROM), or a flash memory. The transitory memory is a RAM, used as an external cache. Through illustrative rather than restrictive description, RAMs of many forms are available, for example, a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DRRAM). It should be noted that the memory involved in the systems and methods described in this specification includes, but is not limited to, these memories and a memory of any other suitable type.

It should be understood that the foregoing description of the memory is exemplary but not limiting. For example, the memory in the embodiments of the present disclosure is alternatively an SRAM, a DRAM, an SDRAM, a DDR SDRAM, an ESDRAM, an SLDRAM, or a DRRAM. In other words, the memory in the embodiments of the present disclosure includes, but not be limited to, these and any other suitable types of memory.

The embodiments of the present disclosure further provide a computer-readable storage medium configured to store one or more computer programs.

Optionally, the computer-readable storage medium is applied to the network device in the embodiments of the present disclosure. The one or more computer programs, when called and run by a computer, cause the computer to execute a corresponding process implemented by the network device in each method in the embodiments of the present disclosure. For brevity, details are not described herein again.

Optionally, the computer-readable storage medium is applied to the first core network device in the embodiments of the present disclosure. The one or more computer programs, when called and run by a computer, cause the computer to execute a corresponding process implemented by the first core network device in each method in the embodiments of the present disclosure. For brevity, details are not described herein again.

Optionally, the computer-readable storage medium is applied to the second core network device in the embodiments of the present disclosure. The one or more computer programs, when called and run by a computer, cause the computer to execute a corresponding process implemented by the second core network device in each method in the embodiments of the present disclosure. For brevity, details are not described herein again.

Optionally, the computer-readable storage medium is applied to the third core network device in the embodiments of the present disclosure. The one or more computer programs, when called and run by a computer, cause the computer to execute a corresponding process implemented by the third core network device in each method in the embodiments of the present disclosure. For brevity, details are not described herein again.

Optionally, the computer-readable storage medium is applied to the fifth core network device in the embodiments of the present disclosure. The one or more computer programs, when called and run by a computer, cause the computer to execute a corresponding process implemented by the fifth core network device in each method in the embodiments of the present disclosure. For brevity, details are not described herein again.

Optionally, the computer-readable storage medium is applied to the terminal device in the embodiments of the present disclosure. The one or more computer programs, when called and run by a computer, cause the computer to execute a corresponding process implemented by the terminal device in each method in the embodiments of the present disclosure. For brevity, details are not described herein again.

The embodiments of the present disclosure further provide a computer program product, including one or more computer program instructions.

Optionally, the computer program product is applied to the network device in the embodiments of the present disclosure. The one or more computer program instructions, when called and executed by a computer, cause the computer to execute a corresponding process implemented by the network device in each method in the embodiments of the present disclosure. For brevity, details are not described herein again.

Optionally, the computer program product is applied to the first core network device in the embodiments of the present disclosure. The one or more computer program instructions, when called and executed by a computer, cause the computer to execute a corresponding process implemented by the first core network device in each method in the embodiments of the present disclosure. For brevity, details are not described herein again.

Optionally, the computer program product is applied to the second core network device in the embodiments of the present disclosure. The one or more computer program instructions, when called and executed by a computer, cause the computer to execute a corresponding process implemented by the second core network device in each method in the embodiments of the present disclosure. For brevity, details are not described herein again.

Optionally, the computer program product is applied to the third core network device in the embodiments of the present disclosure. The one or more computer program instructions, when called and executed by a computer, cause the computer to execute a corresponding process implemented by the third core network device in each method in the embodiments of the present disclosure. For brevity, details are not described herein again.

Optionally, the computer program product is applied to the fifth core network device in the embodiments of the present disclosure. The one or more computer program instructions, when called and executed by a computer, cause the computer to execute a corresponding process implemented by the fifth core network device in each method in the embodiments of the present disclosure. For brevity, details are not described herein again.

Optionally, the computer program product is applied to the terminal device in the embodiments of the present disclosure. The one or more computer program instructions, when called and executed by a computer, cause the computer to execute a corresponding process implemented by the terminal device in each method in the embodiments of the present disclosure. For brevity, details are not described herein again.

The embodiments of the present disclosure further provide a computer program.

Optionally, the computer program is applied to the network device in the embodiments of the present disclosure. The computer program, when called and run by a computer, causes the computer to execute a corresponding process implemented by the network device in each method in the embodiments of the present disclosure. For brevity, details are not described herein again.

Optionally, the computer program is applied to the first core network device in the embodiments of the present disclosure. The computer program, when called and run by a computer, causes the computer to execute a corresponding process implemented by the first core network device in each method in the embodiments of the present disclosure. For brevity, details are not described herein again.

Optionally, the computer program is applied to the second core network device in the embodiments of the present disclosure. The computer program, when called and run by a computer, causes the computer to execute a corresponding process implemented by the second core network device in each method in the embodiments of the present disclosure. For brevity, details are not described herein again.

Optionally, the computer program is applied to the third core network device in the embodiments of the present disclosure. The computer program, when called and run by a computer, causes the computer toexecute a corresponding process implemented by the third core network device in each method in the embodiments of the present disclosure. For brevity, details are not described herein again.

Optionally, the computer program is applied to the fifth core network device in the embodiments of the present disclosure. The computer program, when called and run by a computer, causes the computer to execute a corresponding process implemented by the fifth core network device in each method in the embodiments of the present disclosure. For brevity, details are not described herein again.

Optionally, the computer program is applied to the terminal device in the embodiments of the present disclosure. The computer program, when called and run by a computer, causes the computer to execute a corresponding process implemented by the terminal device in each method in the embodiments of the present disclosure. For brevity, details are not described herein again.

A person of ordinary skill in the art is aware that, in combination with the examples described in the embodiments disclosed in this specification, units and algorithm steps are implemented by electronic hardware or a combination of computer software and electronic hardware. Whether the functions are performed by hardware or software depends on particular applications and design constraints of the technical solutions. A skilled person may use different methods to implement the described functions for each particular application, but it should not be considered that the implementation goes beyond the scope of the present disclosure.

A person skilled in the art can clearly understand that for convenience and brevity of description, reference is made to corresponding processes in the foregoing method embodiments for specific working processes of the foregoing systems, apparatuses, and units. Details are not described herein again.

In the several embodiments provided in the present disclosure, it should be understood that the disclosed systems, apparatuses, and methods may be implemented in other manners. For example, the described apparatus embodiments are merely examples. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented over some interfaces. The indirect couplings or communication connections between the apparatuses or units may be implemented in electrical, mechanical, or other forms.

The units described as separate parts may be or may not be physically separate, and parts displayed as units may be or may not be physical units, may be located in one position, or may be distributed on a plurality of network units. Some or all of the units may be selected based on actual requirements to achieve the objectives of the solutions in the embodiments.

In addition, functional units in the embodiments of the present disclosure may be integrated into one processing unit, each of the units may exist alone physically, or two or more units are integrated into one unit.

If implemented in a form of a software functional unit and sold or used as a standalone product, functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium, and includes instructions for instructing a computer device (which may be a personal computer, a server, a network device, or the like) to perform all or some of the steps of the methods described in the embodiments of the present disclosure. The storage medium includes any medium capable of storing program code, such as a Universal Serial Bus (USB) flash disk, a mobile hard disk, a ROM, a RAM, a magnetic disk, or an optical disk.

The foregoing descriptions are merely specific implementations of the present disclosure, but the protection scope of the present disclosure is not limited thereto. Any variation or replacement readily figured out by a person skilled in the art within the technical scope disclosed in the present disclosure shall fall within the protection scope of the present disclosure. Therefore, the protection scope of the present disclosure should be subject to the protection scope of the claims.

1. A wireless communication method, applicable to a network device, the method comprising:
acquiring first information, wherein the first information is used for requesting target information by a terminal device;
acquiring network consent information of the terminal device based on the first information; and
determining, based on the network consent information of the terminal device, whether the terminal device is allowed to request the target information.

2. The method according to claim 1, wherein the first information comprises at least one of:
identification information of the terminal device, used for identifying the terminal device;
identification information of the target information, used for identifying the target information;
an application ID, used for identifying an application requesting the target information on the terminal device;
an analytics ID corresponding to the target information;
target time information corresponding to the target information; or
target address information corresponding to the target information.

3. The method according to claim 1, wherein the target information comprises at least one of:
analytics information, access management information of the terminal device, or session information of the terminal device.

4. The method according to claim 1, wherein a granularity of the network consent information of the terminal device comprises at least one of:
per terminal device, per analytics ID, or per application ID.

5. The method according to claim 1, wherein the network consent information of the terminal device comprises at least one of:
information indicating whether the terminal device is allowed to request information;
information allowed to be requested;
information not allowed to be requested;
an analytics ID corresponding to information allowed to be requested;
an analytics ID corresponding to information not allowed to be requested;
an application ID of information allowed to be requested;
an application ID of information not allowed to be requested;
time information of information allowed to be requested;
time information of information not allowed to be requested;
address information of information allowed to be requested; or
address information of information not allowed to be requested.

6. The method according to claim 1, wherein the network device is a first core network device.

7. The method according to claim 6, further comprising:
sending a first message to a second core network device in response to determining that the terminal device is not allowed to request the target information, wherein the first message indicates that the terminal device is not allowed to request the target information.

8. The method according to claim 7, wherein the first message further indicates at least one of:
identification information of the terminal device, used for identifying the terminal device;
identification information of the target information, used for identifying the target information;
an application ID, used for identifying an application requesting the target information on the terminal device; or
an analytics ID corresponding to the target information.

9. The method according to claim 7, further comprising:
receiving a second message from the second core network device, wherein the second message indicates that the terminal device cancels a request for the target information.

10. The method according to claim 6, further comprising:
sending the target information to a second core network device in response to determining that the terminal device is allowed to request the target information and the target information is provided by the first core network device.

11. The method according to claim 6, wherein the first information is acquired from a second core network device.

12. The method according to claim 7, wherein the first core network device is a network data analytics function (NWDAF) entity, and the second core network device is a network exposure function (NEF) entity or a newly defined function entity.

13. The method according to claim 1, wherein the network consent information of the terminal device is acquired from a fifth core network device.

14. The method according to claim 13, wherein acquiring the network consent information of the terminal device based on the first information comprises:
sending the first information to the fifth core network device; and
receiving the network consent information of the terminal device from the fifth core network device.

15. A network device, comprising:
a processor and a memory storing one or more computer programs, which when executed by the processor, causes the network device to:
acquire first information, wherein the first information is used for requesting target information by a terminal device;
acquire network consent information of the terminal device based on the first information; and
determine, based on the network consent information of the terminal device, whether the terminal device is allowed to request the target information.

16. The network device according to claim 15, wherein the first information comprises at least one of:
identification information of the terminal device, used for identifying the terminal device;
identification information of the target information, used for identifying the target information;
an application ID, used for identifying an application requesting the target information on the terminal device;
an analytics ID corresponding to the target information;
target time information corresponding to the target information; or
target address information corresponding to the target information.

17. The network device according to claim 15, wherein the target information comprises at least one of:
analytics information, access management information of the terminal device, or session information of the terminal device.

18. The network device according to claim 15, wherein a granularity of the network consent information of the terminal device comprises at least one of:
per terminal device, per analytics ID, or per application ID.

19. The network device according to claim 15, wherein the network consent information of the terminal device comprises at least one of:
information indicating whether the terminal device is allowed to request information;
information allowed to be requested;
information not allowed to be requested;
an analytics ID corresponding to information allowed to be requested;
an analytics ID corresponding to information not allowed to be requested;
an application ID of information allowed to be requested;
an application ID of information not allowed to be requested;
time information of information allowed to be requested;
time information of information not allowed to be requested;
address information of information allowed to be requested; or
address information of information not allowed to be requested.

20. The network device according to claim 15, wherein the network device is a first core network device;
wherein the one or more computer programs, which when executed by the processor, further causes the network device to:
send a first message to a second core network device in response to determining that the terminal device is not allowed to request the target information, wherein the first message indicates that the terminal device is not allowed to request the target information.
